(19) United States
(12) Patent Application Publication
(10) Pub. No.: US 2025/0206660 A1
(43) Pub. Date: Jun. 26, 2025

(54) Solar Control Coating With Enhanced Solar Heat Gain

(71) Applicant: Vitro Flat Glass LLC, Cheswick, PA (US)

(72) Inventor: Patrick Fisher, Pittsburgh, PA (US)

(21) Appl. No.: 18/985,246

(22) Filed: Dec. 18, 2024

Related U.S. Application Data
(60) Provisional application No. 63/613,084, filed on Dec. 21, 2023.

(51) Int. Cl. C03C 17/36

(52) U.S. Cl. CPC C03C 17/366; C03C 17/3618; C03C 17/3639; C03C 17/3655; C03C 2217/216; C03C 2217/228; C03C 2217/74; C03C 2217/944; C03C 2218/156

(57) ABSTRACT

Provided herein are coated articles and coated transparencies having a functional coating. The functional coating includes a first dielectric layer, a first metallic layer over the first dielectric layer, a first primer layer over the first metallic layer, a second dielectric layer over the first primer layer, the second dielectric layer includes: a first film over the first primer layer, a second film over the first film, a third film over the second film, a fourth film over the third film, and a fifth film over the fourth film, a second metallic layer over the fifth film of the second dielectric layer, a second primer layer over the second metallic layer, a third dielectric layer over the second primer layer, and a protective layer over the third dielectric layer. The functional coating provides a reference insulating glass unit solar heat gain coefficient of less than or equal to 0.38.

### CROSS-REFERENCE TO RELATED APPLICATIONS

This application claims priority to U.S. Provisional Application No. 63/613,084, filed Dec. 21, 2023, the disclosure of which is incorporated by reference in its entirety.

### BACKGROUND OF THE INVENTION

### Field of the Invention

This invention relates generally to coated articles and coated transparencies having a functional coating, where the functional coating provides a reference insulating glass unit (IGU) solar heat gain coefficient (SHGC) of less than or equal to 0.38.

### Background of the Invention

Solar control coatings block or filter selected ranges of electromagnetic radiation, typically radiation in the infrared region and/or ultraviolet region of the electromagnetic spectrum. These solar control coatings are placed on transparencies, such as windows, to reduce the amount of selected ranges of solar energy entering a building. This reduces the heat buildup inside the building.

The solar heat gain coefficient (SHGC) is a measure of how well the solar control coating blocks solar heat. The lower the SHGC, the more solar heat is blocked, i.e., the lower the solar heat buildup inside the building. The light to solar gain (LSG) ratio is the ratio of the transmittance of visible light divided by the SHGC. The overall heat transfer coefficient (U Factor) is a measure of heat loss, e.g., through the window. The lower the U factor, the lower the heat transfer through the window, i.e., the higher the insulating level of the window.

While solar control coatings provide good solar insulation properties, it would be useful to improve the solar control properties of these coatings. For example, it would be useful to decrease the SHGC. To decrease the SHGC, the thicknesses of the infrared reflective metal layers of the solar control coating could be increased. However, this would also make the solar control coating more reflective of visible light. Consumers prefer transparencies with high visible light transmittance but low visible light reflectance (both interior and exterior visible light reflectance). Further, increasing the thicknesses of the infrared reflective metal layers increases the sensitivity of the solar control coating to random or systematic variations in the thicknesses of the films making up the coating. This can alter or adversely impact upon the performance of the coating or the aesthetics of the coating. Additionally, increasing the thicknesses of the infrared reflective metal layers tends to decrease the durability of the coating to chemical and/or mechanical attack. Moreover, the accessible regions of the aesthetic/color space that are most broadly appealing and that can be reached using conventional solar control coatings employing one or more periods of dielectric/silver/dielectric structures, are constrained by the designs of conventional solar control coatings.

Thus, it would be desirable to provide a solar control coating having a low SHGC, while reducing the total number of the infrared reflective metal layers of the solar control coating, to prevent heat buildup inside of a building.

### SUMMARY OF THE INVENTION

The invention relates to a coated article. The coated article comprising a substrate comprising a first surface and a second surface opposite the first surface; and a functional coating positioned over at least a portion of the second surface of the substrate. The functional coating comprises: a first dielectric layer positioned over at least a portion of the second surface of the substrate; a first metallic layer positioned over at least a portion of the first dielectric layer, the first metallic layer comprising a first thickness; a first primer layer positioned over at least a portion of the first metallic layer; a second dielectric layer positioned over at least a portion of the first primer layer, the second dielectric layer comprising: a first film positioned over at least a portion of the first primer layer, a second film positioned over at least a portion of the first film, a third film positioned over at least a portion of the second film, a fourth film positioned over at least a portion of the third film, and a fifth film positioned over at least a portion of the fourth film; a second metallic layer positioned over at least a portion of the fifth film of the second dielectric layer, the second metallic layer comprising a second thickness; a second primer layer positioned over at least a portion of the second metallic layer; a third dielectric layer positioned over at least a portion of the second primer layer; and a protective layer positioned over at least a portion of the third dielectric layer. The functional coating provides a reference insulating glass unit (IGU) solar heat gain coefficient (SHGC) of less than or equal to 0.38.

The invention also relates to a coated transparency. The coated transparency comprises a first substrate comprising a No. 1 surface and a No. 2 surface opposite the No. 1 surface, a second substrate comprising a No. 3 surface and a No. 4 surface opposite the No. 3 surface, wherein the second substrate is spaced apart from the first substrate, wherein the No. 3 surface faces the No. 2 surface, and wherein the first substrate and the second substrate are connected together; and a functional coating positioned over the No. 2 surface of the first substrate or the No. 3 surface of the second substrate. The functional coating comprises: a first dielectric layer positioned over at least a portion of the No. 2 surface of the first substrate or the No. 3 surface of the second substrate; a first metallic layer positioned over at least a portion of the first dielectric layer, the first metallic layer comprising a first thickness; a first primer layer positioned over at least a portion of the first metallic layer; a second dielectric layer positioned over at least a portion of the first primer layer, the second dielectric layer comprising: a first film positioned over at least a portion of the first primer layer, a second film positioned over at least a portion of the first film, a third film positioned over at least a portion of the second film, a fourth film positioned over at least a portion of the third film, and a fifth film positioned over at least a portion of the fourth film; a second metallic layer positioned over at least a portion of the fifth film of the second dielectric layer, the second metallic layer comprising a second thickness; a second primer layer positioned over at least a portion of the second metallic layer; a third dielectric layer positioned over at least a portion of the second primer layer; and a protective layer positioned over at least a portion of the third dielectric layer. The coated transparency comprises a solar heat gain coefficient (SHGC) of less than 0.38.

The invention also relates to a method of reducing a solar heat gain coefficient (SHGC) of an insulating glass unit. The method comprises providing a first substrate comprising a No. 1 surface and a No. 2 surface opposite the first surface; providing a second substrate comprising a No. 3 surface and a No. 4 surface opposite the No. 3 surface, wherein the second substrate is spaced apart from the first substrate, wherein the No. 3 surface faces the No. 2 surface, and wherein the first substrate and the second substrate are connected together; and forming a functional coating over at least a portion of the No. 2 surface of the first substrate or the No. 3 surface of the second substrate. Forming the functional coating comprises: forming a first dielectric layer over at least a portion of the No. 2 surface of the first substrate or the No. 3 surface of the second substrate; forming a first metallic layer over at least a portion of the first dielectric layer, the first metallic layer comprising a first thickness; forming a first primer layer over at least a portion of the first metallic layer; forming a second dielectric layer positioned over at least a portion of the first primer layer, wherein forming the second dielectric layer comprises: forming a first film over at least a portion of the first primer layer, forming a second film over at least a portion of the first film, forming a third film over at least a portion of the second film, forming a fourth film over at least a portion of the third film, and forming a fifth film over at least a portion of the fourth film; forming a second metallic layer over at least a portion of the fifth film of the second dielectric layer, the second metallic layer comprising a second thickness; forming a second primer layer over at least a portion of the second metallic layer; forming a third dielectric layer over at least a portion of the second primer layer; and forming a protective layer over at least a portion of the third dielectric layer. The functional coating provides the insulating glass unit with a SHGC of less than or equal to 0.38.

The invention also relates to a method of making a coated article. The method comprises providing a substrate comprising a first surface and a second surface opposite the first surface; and forming a functional coating over at least a portion of the second surface of the substrate. Forming the functional coating comprises: forming a first dielectric layer over at least a portion of the second surface of the first substrate; forming a first metallic layer over at least a portion of the first dielectric layer, the first metallic layer comprising a first thickness; forming a first primer layer over at least a portion of the first metallic layer; forming a second dielectric layer over at least a portion of the first primer layer, wherein forming the second dielectric layer comprises: forming a first film over at least a portion of the first primer layer, forming a second film over at least a portion of the first film, forming a third film over at least a portion of the second film, forming a fourth film over at least a portion of the third film, and forming a fifth film over at least a portion of the fourth film; forming a second metallic layer over at least a portion of the fifth film of the second dielectric layer, the second metallic layer comprising a second thickness; forming a second primer layer over at least a portion of the second metallic layer; forming a third dielectric layer over at least a portion of the second primer layer; and forming a protective layer over at least a portion of the third dielectric layer. The functional coating provides a reference insulating glass unit (IGU) solar heat gain coefficient (SHGC) of less than or equal to 0.38.

### BRIEF DESCRIPTION OF THE DRAWINGS

The invention will be described with reference to the following drawing figures wherein like reference numbers identify the parts throughout.

FIG. 1 is a side view (not to scale) of a coated article according to an example of the invention.

FIG. 2 is a side view (not to scale) of a coated article according to an example of the invention.

FIGS. 3A and 3B are side views (not to scale) of exemplary coated transparancies according to examples of the invention.

### DESCRIPTION OF THE INVENTION

As used herein, spatial or directional terms, such as “left”, “right”, “inner”, “outer”, “above”, “below”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. Further, as used herein, the terms “formed over”, “deposited over”, or “provided over” mean formed, deposited, or provided on but not necessarily in contact with the surface. For example, a coating layer “formed over” a substrate does not preclude the presence of one or more other coating layers or films of the same or different composition located between the formed coating layer and the substrate. The terms “visible region”, “visible light”, or “visible light spectrum” refer to electromagnetic radiation having a wavelength in the range of 380 nm to 800 nm. The terms “infrared region”, “infrared radiation”, or “infrared spectrum” refer to electromagnetic radiation having a wavelength in the range of greater than 800 nm to 100,000 nm. The terms “ultraviolet region”, “ultraviolet radiation”, or “ultraviolet (UV) spectrum” mean electromagnetic energy having a wavelength in the range of 300 nm to less than 380 nm. Additionally, all documents, such as, but not limited to, issued patents and patent applications, referred to herein are to be considered to be “incorporated by reference” in their entirety. As used herein, the term “film” refers to a coating region of a desired or selected coating composition. A “layer” can comprise one or more “films”, and a “coating” or “coating stack” can comprise one or more “layers”. The term “asymmetrical reflectivity” means that the visible light reflectance of the coating from one side is different than that of the coating from the opposite side. The term “critical thickness” means a thickness above which a coating material forms a continuous, uninterrupted layer and below which the coating material forms discontinuous regions or islands of the coating material rather than a continuous layer. The term “subcritical thickness” means a thickness below the critical thickness such that the coating material forms isolated, non-connected regions of the coating material. The term “islanded” means that the coating material is not a continuous layer but, rather, that the material is deposited to form isolated regions or islands.

Weight percentages (wt. %) of the metal oxides, metal alloys, metal nitrides, or metal oxynitrides, as used herein, are based on the total weight of the metal components and exclude the weight of any oxide, nitride, or oxynitride components.

The invention is directed to a coated article 10. The coated article 10 comprises: a substrate 12 comprising a first surface 14 and a second surface 16 opposite the first surface 14; and a functional coating 30 positioned over at least a portion of the second surface 16 of the substrate 12. The functional coating 30 comprises: a first dielectric layer 32 positioned over at least a portion of the second surface 16 of the first substrate 12; a first metallic layer 38 positioned over at least a portion of the first dielectric layer 32, the first metallic layer 38 comprising a first thickness; a first primer layer 40 positioned over at least a portion of the first metallic layer 38; a second dielectric layer 42 positioned over at least a portion of the first primer layer 40, the second dielectric layer 42 comprising: a first film 44 positioned over at least a portion of the first primer layer 40, a second film 46 positioned over at least a portion of the first film 44, a third film 48 positioned over at least a portion of the second film 46, a fourth film 50 positioned over at least a portion of the third film 48, and a fifth film 52 positioned over at least a portion of the fourth film 50; a second metallic layer 54 positioned over at least a portion of the fifth film 52 of the second dielectric layer 42, the second metallic layer 54 comprising a second thickness; a second primer layer 56 positioned over at least a portion of the second metallic layer 54; a third dielectric layer 58 positioned over at least a portion of the second primer layer 56; and a protective layer 64 positioned over at least a portion of the third dielectric layer 58. The functional coating 30 provides a reference insulating glass unit (IGU) solar heat gain coefficient (SHGC) of less than or equal to 0.38.

The coated article 10 comprises a substrate 12. The substrate 12 comprises a first side comprising a first surface 14 and a second side comprising a second surface 16, where the second surface 16 is opposite the first surface 14.

The substrate 12 can be of any desired material having any desired characteristics, such as opaque, translucent, or transparent to visible light. For example, the substrate 12 can be transparent or translucent to visible light. By “transparent” is meant having visible light transmission of greater than 0% up to 100%. Alternatively, the substrate 12 can be translucent. By “translucent” is meant allowing electromagnetic energy (e.g., visible light) to pass through but diffusing this energy such that objects on the side opposite the viewer are not clearly visible. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, the substrate 12 can be conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible transmission, ultraviolet transmission, infrared transmission, and/or total solar energy transmission. By “float glass” is meant glass formed by a conventional float process in which molten glass is deposited onto a molten metal bath and controllably cooled to form a float glass ribbon. Examples of float glass processes are disclosed in U.S. Pat. Nos. 4,466,562 and 4,671,155.

The substrate 12 may comprise, for example, clear float glass or can be tinted or colored glass. The substrate 12 can be of any desired dimensions, e.g., length, width, shape, or thickness. In one non-limiting embodiment in which the substrate is an architectural transparency, the substrate 12 may be 1 mm to 30 mm thick, such as 2.5 mm to 25 mm thick, such as 2.5 mm to 10 mm. As used herein, the term “architectural transparency” refers to any transparency located on a building, such as, but not limited to, windows and sky lights. However, it is to be understood that the invention is not limited to use with such architectural transparencies but could be practiced with transparencies in any desired field, such as, but not limited to, laminated or non-laminated residential and/or commercial windows, insulating glass units, and/or transparencies for land, air, space, above water and underwater vehicles, as well as personal transparencies such as glasses and the like. Therefore, it is to be understood that the specifically disclosed exemplary embodiments are presented simply to explain the general concepts of the invention, and that the invention is not limited to these specific exemplary embodiments. Additionally, while a typical “transparency” can have sufficient visible light transmission such that materials can be viewed through the transparency, in the practice of the invention, the “transparency” need not be transparent to visible light but may be translucent or opaque.

In some embodiments, the substrate 12 can be a monolithic glazing. By “monolithic” is meant having a single structural support or structural member, e.g. having a single substrate.

The functional coating 30 is positioned over at least a portion of the second surface 16 of the substrate 12.

The functional coating 30 is a double metallic coating (e.g., two metallic layers). The functional coating 30 consists of two metallic layers.

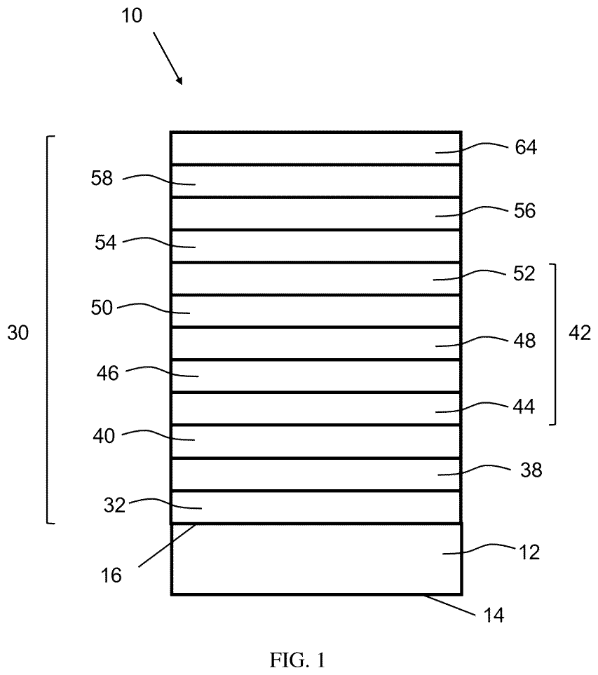

An exemplary functional coating 30 is provided in FIG. 1. The functional coating 30 includes a first dielectric layer 32 positioned over and in direct contact with at least a portion of the second surface 16 of the substrate 12. A first metallic layer 38 positioned over and in direct contact with at least a portion of the first dielectric layer 32. The first metallic layer 38 includes a first thickness. A first primer layer 40 is positioned over and in direct contact with at least a portion of the first metallic layer 38. A second dielectric layer 42 is positioned over and in direct contact with at least a portion of the first primer layer 40. The second dielectric layer 42 includes a first film 44 positioned over and in direct contact with at least a portion of the first primer layer 40, a second film 46 positioned over and in direct contact with at least a portion of the first film 44, a third film 48 positioned over and in direct contact with at least a portion of the second film 46, a fourth film 50 positioned over and in direct contact with at least a portion of the third film 48, and a fifth film 52 positioned over and in direct contact with at least a portion of the fourth film 50. A second metallic layer 54 is positioned over and in direct contact with at least a portion of the fifth film 52 of the second dielectric layer 42. The second metallic layer 54 includes a second thickness. A second primer layer 56 is positioned over and in direct contact with at least a portion of the second metallic layer 54. A third dielectric layer 58 is positioned over and in direct contact with at least a portion of the second primer layer 56. A protective layer 64 is positioned over and in direct contact with at least a portion of the third dielectric layer 58.

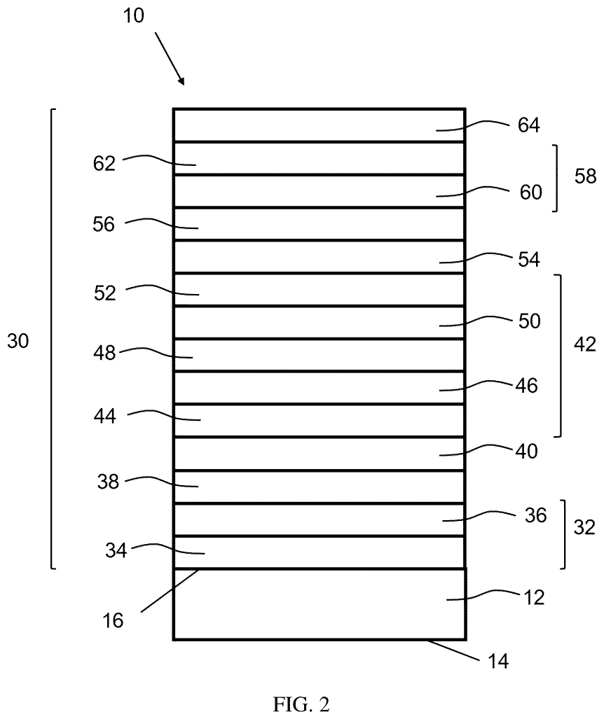

The functional coating 30 includes a first dielectric layer 32 positioned over and in direct contact with at least a portion of the second surface 16 of the substrate 12. As shown in FIG. 2, the first dielectric layer 32 may include a first film 34 positioned over and in direct contact with the second surface 16 of the substrate 12 and a second film 36 positioned over and in direct contact with the first film 34. The first film 34 may be positioned over and in direct contact with a portion of the second surface 16 of the substrate 12 or the entire second surface 16 of the substrate 12. The first dielectric layer 32 can be transparent to visible light.

The first film 34 of the first dielectric layer 32 can comprise metal or metal alloy oxides, nitrides, oxynitrides, or mixtures thereof. Examples of suitable metal oxides, metal nitrides, and/or metal oxynitrides include oxides, nitrides, and/or oxynitrides of titanium, hafnium, zirconium, niobium, zinc, bismuth, lead, indium, tin, aluminum, silicon and mixtures thereof. The metal oxides can have small amounts of other materials, such as manganese in bismuth oxide, tin in indium oxide, etc. Additionally, oxides or nitrides of metal alloys or metal mixtures can be used, such as oxides containing zinc and tin (e.g., zinc stannate, defined below), oxides of indium-tin alloys, silicon aluminum nitrides, or aluminum nitrides. Further, doped metal oxides, such as antimony or indium tin oxides or nickel or boron doped silicon oxides, can be used. Alternatively, the first film 34 of the first dielectric layer 32 can comprise a transparent conductive oxide. The transparent conductive oxide can be a doped metal oxide such as gallium-doped zinc oxide (GZO), aluminum-doped zinc oxide (AZO), indium-doped zinc oxide (IZO) magnesium-doped zinc oxide (MZO), or tin-doped indium oxide (ITO). The first film 34 of the first dielectric layer 32 may comprise silicon oxide, silicon aluminum nitride, silicon aluminum oxide, silicon oxynitride, silicon aluminum oxynitride, zinc stannate, or tin oxide. The first dielectric layer 32 is free of silicon nitride. The first dielectric layer 32 is free of metallic zinc.

As used herein “free of silicon nitride” means that there is no intentional addition of silicon nitride in the dielectric layer. As used herein “free of metallic zinc” means that the dielectric layer does not include pure zinc metal.

The first film 34 of the first dielectric layer 32 may comprise silicon oxide and be sputtered from a single cathode containing silicon. The first film 34 of the first dielectric layer 32 may comprise silicon aluminum nitride or silicon aluminum oxide and be sputtered from two cathodes (e.g., one silicon and one aluminum) or from a single cathode containing both silicon and aluminum. The first film 34 of the first dielectric layer 32 may be silicon aluminum nitride or silicon aluminum oxide comprising from 5 wt. % to 20 wt. % aluminum and 95 wt. 9% to 80 wt. % silicon, such as 10 wt. % to 20 wt. % aluminum and 90 wt. % to 80 wt. % silicon, such as 20 wt. % to 25 wt. % aluminum and 80 wt. % to 75 wt. % silicon. The first film 34 of the first dielectric layer 32 may be silicon aluminum nitride or silicon aluminum oxide comprising silicon and aluminum in amount of at least 95 wt. % silicon and at least 5 wt. % aluminum. The first film 34 of the first dielectric layer 32 may be silicon aluminum nitride or silicon aluminum oxide comprising silicon and aluminum in an amount of at least 90 wt. % silicon and at least 10 wt. % aluminum. The first film 34 of the first dielectric layer 32 may be silicon aluminum nitride or silicon aluminum oxide comprising silicon and aluminum in an amount of at least 85 wt. % silicon and at least 15 wt. % aluminum. The first film 34 of the first dielectric layer 32 may be silicon aluminum nitride or silicon aluminum oxide comprising silicon and aluminum in an amount of at least 80 wt. % silicon and at least 20 wt. % aluminum. The first film 34 of the first dielectric layer 32 may be silicon aluminum nitride or silicon aluminum oxide comprising silicon and aluminum in an amount of at least 75 wt. % silicon and at least 25 wt. % aluminum.

The first film 34 of the first dielectric layer 32 may be formed by sputtering silicon aluminum in a nitrogen (N₂) atmosphere that has a specific flow rate as to form an atmosphere of greater than 0% N₂ to less than or equal to 100% N₂. The flow rate is an approximation to the amount of N₂ in the atmosphere, but one of ordinary skill in the art would recognize that N₂ and/or oxygen (O₂) may leak into the coating chamber if there are any leaks from the external atmosphere into the coating chamber. For example, the N₂ flow rate (i.e. the concentration of N₂ in the atmosphere for the chamber where the material is being deposited) in the coating chamber can be in the range of 10% to 100%, such as 20% to 100%, such as 30% to 100%, such as 40% to 100%, such as 50% to 100%.

The first film 34 of the first dielectric layer 32 may be formed by sputtering the silicon or silicon aluminum in an oxygen (O₂) atmosphere that has a specific flow rate as to form an atmosphere of greater than 0% O₂ to less than or equal to 50% O₂. The flow rate is an approximation to the amount of O₂ in the atmosphere, but one of ordinary skill in the art would recognize that N₂ and/or O₂ may leak into the coating chamber if there are any leaks from the external atmosphere into the coating chamber. For example, the O₂ flow rate (i.e. the concentration of O₂ in the atmosphere for the chamber where the material is being deposited) in the coating chamber can be greater than 0%, such as in the range of 0% to 50%, such as 10% to 50%, such as 20% to 30%, such as 20% to 40%, such as 20% to 50%, such as 30% to 40%, or such as 30% to 50%.

The remainder of the atmosphere in either case (N₂ or O₂ atmosphere) can be an inert gas, such as, argon.

The tin oxide can be deposited in an oxygen (O₂) environment from a tin target or from a tin target that includes other materials to improve the sputtering characteristics of the target. For example, the O₂ flow rate (i.e., concentration of O₂ in the atmosphere for the chamber where the material is being deposited) can be up to 80% O₂, such as, 80% O₂, 75% O₂, or 70% O₂. The remainder of the atmosphere can be an inert gas, such as, argon. The tin oxide can be obtained from magnetron sputtering vacuum deposition from a target of tin or a target of tin and zinc. For example, the tin target can include a small amount (e.g., up to 20 wt. %, up to 15 wt. %, up to 10 wt. %, or up to 5 wt. %) of zinc. In which case, the resultant tin oxide film would include a small percentage of zinc oxide, e.g., up to 20 wt. % zinc oxide, e.g., up to 10 wt. % zinc oxide, e.g., up to 5 wt. % zinc oxide. A coating layer deposited from a tin target having up to from 0 wt. % to 20 wt. % zinc is referred to herein as “a tin oxide film”. The first film 34 of the first dielectric layer 32 may be a tin oxide film where tin is substantially the only metal in the first film 34. As used herein, “substantially free” means that the tin oxide film contains less than 0.5 wt. % of additional metals other than tin. The tin oxide film 34 may include 80 wt. % tin oxide and 20 wt. % zinc oxide. The tin-zinc oxide film 34 may include 90% tin oxide and 10 wt. % zinc oxide.

By “zinc stannate” is meant a composition of Zn_{X}Sn_{1-X}O_{2-X} (Formula 1) where “x” varies in the range of greater than 0 to less than 1. For instance, “x” can be greater than 0 and can be any fraction or decimal between greater than 0 to less than 1. For example, where x=⅔, Formula 1 is Zn_{2/3}Sn_{1/3}O_{4/3}, which is more commonly described as “Zn₂SnO₄”. A zinc stannate-containing film has one or more of the forms of Formula 1 in a predominant amount in the layer. The zinc stannate layer is a stoichiometrically fully oxidized layer and is not intentionally left as a suboxide. For example, the zinc stannate layer contains greater than 50% oxygen based on atomic percent.

The first film 34 of the first dielectric layer 32 can comprise a total thickness of from 18 nm to 29 nm, such as from 20 nm to 27 nm, such as from 21 nm to 26 nm, or such as from 22.5 nm to 24.5 nm.

The second film 36 of the first dielectric layer 32 can comprise antireflective materials and/or dielectric materials, such as, but not limited to, metal or metal alloy oxides, nitrides, oxynitrides, or mixtures thereof. Examples of suitable metal oxides for the second film 36 of the first dielectric layer 32 include oxides of titanium, hafnium, zirconium, niobium, zinc, bismuth, lead, indium, tin, aluminum, silicon and mixtures thereof. These metal oxides can have small amounts of other materials, such as, manganese in bismuth oxide, tin in indium oxide, etc. Additionally, oxides of metal alloys or metal mixtures can be used, such as, oxides containing zinc and tin, oxides of indium-tin alloys, oxides containing zinc and aluminum, silicon aluminum nitrides, or aluminum nitrides. Further, doped metal oxides, such as, antimony or indium doped tin oxides or nickel or boron doped silicon oxides, can be used. The second film 36 of the first dielectric layer 32 can comprise a transparent conductive oxide. The transparent conductive oxide of the second film 36 of the first dielectric layer 32 can be a doped metal oxide such as gallium-doped zinc oxide (GZO), aluminum-doped zinc oxide (AZO), indium-doped zinc oxide (IZO), magnesium-doped zinc oxide (MZO), or tin-doped indium oxide (ITO).

The second film 36 of the first dielectric layer 32 can be a zinc/tin alloy oxide. By “zinc/tin alloy oxide” is meant both true alloys, and mixtures of the oxides. Zinc oxide can be deposited from a zinc target that includes other materials to improve the sputtering characteristics of the target. As such, the zinc/tin alloy oxide can be obtained from magnetron sputtering vacuum deposition from a target of zinc and tin. For example, the zinc target can include a small amount (e.g., up to 20 wt. %, up to 15 wt. %, up to 10 wt. %, or up to 5 wt. %) of tin to improve sputtering. In which case, the resultant zinc oxide film would include a small percentage of tin oxide, e.g., up to 10 wt. % tin oxide, e.g., up to 5 wt. % tin oxide. A coating layer deposited from a zinc target having up to 10 wt. % tin (added to enhance the conductivity of the target) is referred to herein as “a zinc oxide film” even though a small amount of tin may be present. One non-limiting target can comprise zinc and tin in proportions of from 5 wt. % to 95 wt. % zinc and from 95 wt. % to 5 wt. % tin, such as, from 10 wt. % to 90 wt. % zinc and from 90 wt. % to 10 wt. % tin. However, other ratios of zinc to tin could also be used.

The second film 36 of the first dielectric layer 32 can comprise a film of zinc oxide or aluminum zinc oxide film (AlₓZn₁₋ₓ oxide). By “aluminum/zinc alloy oxide” is meant both true alloys, and mixtures of the oxides. As such, the aluminum/zinc alloy oxide can be obtained from magnetron sputtering vacuum deposition from a target of zinc and aluminum and can include a small of amount (e.g. less than 10 wt. %, such as, greater than 0 to 5 wt. %) of tin to improve sputtering. In which case, the resultant aluminum zinc oxide film would include a small percentage of tin oxide, e.g. 0 wt. % to less than 10 wt. %, e.g., 0 wt. % to 5 wt. % tin oxide. The second film 36 of the first dielectric layer 32 can comprise AlₓZn₁₋ₓ oxide, where x is within the range of 1 wt. % to 25 wt. %, such as, 1 wt. % to 15 wt. %, such as, 1 wt. % to 10 wt. %, such as, 2 wt. % to 5 wt. %. In one non-limiting embodiment, x is 3 wt. %.

The second film 36 of the first dielectric layer 32 can comprise a film of titanium oxide, which is defined as a compound comprising both titanium and oxygen. The titanium oxide may comprise, for example, titanium oxide, titanium aluminum oxide, titanium oxynitride, titanium aluminum oxynitride, or any mixtures thereof.

The second film 36 of the first dielectric layer 32 may comprise a total thickness of from 4 nm to 12 nm, such as from 5 nm to 11 nm, such as from 6 nm to 10 nm, or such as from 7 nm to 9 nm.

The first film 34 of the first dielectric layer 32 may comprise tin oxide positioned over and in direct contact with the second surface 16 of the substrate 12 and the second film 36 of the first dielectric layer 32 may comprise zinc oxide positioned over and in direct contact with the first film 34. Alternatively, the first film 34 of the first dielectric layer 32 may comprise zinc stannate positioned over and in direct contact with the second surface 16 of the substrate 12 and the second film 36 of the first dielectric layer 32 may comprise zinc oxide positioned over and in direct contact with the first film 34.

The first dielectric layer 32 may comprise three films. For example, the first dielectric layer 32 may include a first film 34 positioned over and in direct contact with the second surface 16 of the substrate 12, a second film 36 positioned over and in direct contact with the first film 34, and a third film positioned over and in direct contact with the second film 36.

The first film 34 of the first dielectric layer 32 may comprise tin oxide positioned over and in direct contact with the second surface 16 of the substrate 12, the second film 36 may comprise zinc stannate positioned over and in direct contact with the first film 34, and the third film may comprise zinc oxide positioned over and in direct contact with the second film 36.

The first dielectric layer 32 can comprise a total thickness (e.g., combined thickness of the first film 34, second film 36, and optional third film) of from 22 nm to 41 nm, such as from 25 nm to 38 nm, such as from 27 nm to 36 nm, or such as from 29.5 nm to 33.5 nm.

A first metallic layer 38 is positioned over and in direct contact with at least a portion of the first dielectric layer 32, such as over at least a portion of the second film 36 or the optional third film of the first dielectric layer 32. The first metallic layer 38 can include a reflective metal, such as, but not limited to, metallic gold, copper, palladium, aluminum, silver, or mixtures, alloys, or combinations thereof. In one embodiment, the first metallic layer 38 comprises a metallic silver layer.

The first metallic layer 38 is a continuous layer. By “continuous layer” is meant that the coating forms a continuous film of the material and not isolated coating regions.

The first metallic layer 38 has a first thickness. The first thickness of the first metallic layer 38 is in the range of from 10.5 nm to 16.5 nm, such as from 11 nm to 16 nm, such as from 11.5 nm to 15.5 nm, or such as from 12.5 nm to 14.5 nm.

A first primer layer 40 is positioned over and in direct contact with the first metallic layer 38. The first primer layer 40 can be a single film or a multiple film layer. The first primer layer 40 can include an oxygen-capturing material that can be sacrificial during the deposition process to prevent degradation or oxidation of the first metallic layer 38 during the sputtering process or subsequent heating processes. The first primer layer 40 can also absorb at least a portion of electromagnetic radiation, such as, visible light, passing through the functional coating 30. Examples of materials useful for the first primer layer 40 include titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof. In one non-limiting embodiment, the first primer layer 40 comprises titanium, titanium and aluminum, or zinc and aluminum, which are deposited as a metal and at least a portion of the titanium, or titanium and aluminum, or zinc and aluminum are subsequently oxidized. In another embodiment, the first primer layer 40 comprises a nickel-chromium alloy, such as, Inconel. In another embodiment, the first primer layer 40 comprises a cobalt-chromium alloy, such as, Stellite®.

The first primer layer 40 can have a thickness in the range of from 0.5 nm to 5 nm, such as from 1 nm to 4 nm, such as from 1.5 nm to 3.5 nm, or such as from 2 nm to 3 nm.

A second dielectric layer 42 is positioned over and in direct contact with at least a portion of the first primer layer 40. The second dielectric layer 42 includes a first film 44 positioned over and in direct contact with at least a portion of the first primer layer 40, a second film 46 positioned over and in direct contact with at least a portion of the first film 44, a third film 48 positioned over and in direct contact with at least a portion of the second film 46, a fourth film 50 positioned over and in direct contact with at least a portion of the third film 48, and a fifth film 52 positioned over and in direct contact with at least a portion of the fourth film 50.

The first film 44, second film 46, third film 48, fourth film 50, and the fifth film 52 can comprise one or more metal oxide, metal alloy oxide, metal nitride, metal alloy nitride, metal oxynitride, or metal alloy oxynitride-containing films, such as, those described above with respect to the first film 34 and second film 36 of the first dielectric layer 32. The first film 44, the third film 48, and the fifth film 52 of the second dielectric layer 42 comprise a first material. The second film 46 and the fourth film 50 of the second dielectric layer 42 comprise a second material. The first material is different from second material. The second dielectric layer 42 is free of silicon nitride. The second dielectric layer 42 is free of metallic zinc.

The first film 44, the third film 48, and the fifth film 52 of the second dielectric layer 42 may comprise a metal oxide, e.g., a zinc oxide or an aluminum zinc oxide film. The second film 46 and the fourth film 50 of the second dielectric layer 42 may comprise a metal alloy film, e.g., a zinc stannate film. For example, the first film 44 may comprise zinc oxide, the second film 46 may comprise zinc stannate, the third film 48 may comprise zinc oxide, the fourth film 50 may comprise zinc stannate, and the fifth film 52 may comprise zinc oxide.

The first film 44 of the second dielectric layer 42 may comprise a thickness in the range of from 4 nm to 12 nm, such as from 5 nm to 11 nm, such as from 6 nm to 10 nm, or such as from 7 nm to 9 nm.

The second film 46 of the second dielectric layer 42 may comprise a thickness in the range of from 10 nm to 45 nm, such as from 18 nm to 30 nm, such as from 21 nm to 26 nm, or such as from 22.5 nm to 24.5 nm.

The third film 48 of the second dielectric layer 42 may comprise a thickness in the range of from 7 nm to 35 nm, such as from 16 nm to 25 nm, such as from 18 nm to 23 nm, or such as from 18.5 nm to 21.5 nm.

The fourth film 50 of the second dielectric layer 42 may comprise a thickness in the range of from 10 nm to 45 nm, such as from 18 nm to 31 nm, such as from 19 nm to 27 nm, or such as from 23 nm to 25 nm.

The fifth film 52 of the second dielectric layer 42 may comprise a thickness in the range of from 4 nm to 12 nm, such as from 5 nm to 11 nm, such as from 6 nm to 10 nm, or such as from 7 nm to 9 nm.

The second dielectric layer 42 may comprise a total thickness (e.g., combined thickness of the first film 44, second film 46, third film 48, fourth film 50, and fifth film 52) in the range of from 35 nm to 149 nm, such as from 62 nm to 108 nm, such as from 70 nm to 96 nm, or such as from 78 nm to 89 nm.

A second metallic layer 54 is positioned over and in direct contact with at least a portion of the fifth film 52 of the second dielectric layer 42. The second metallic layer 54 can include a reflective metal, such as, but not limited to, metallic gold, copper, palladium, aluminum, silver, or mixtures, alloys, or combinations thereof. In one embodiment, the second metallic layer 54 comprises a metallic silver layer.

The second metallic layer 54 is a continuous layer.

The second metallic layer 54 has a second thickness. The second thickness of the second metallic layer 54 is in the range of from 11 nm to 18 nm, such as from 12 nm to 17 nm, such as from 12.5 nm to 16.5 nm, or such as from 13.5 nm to 15.5 nm.

The second thickness of the second metallic layer 54 may be greater than the first thickness of the first metallic layer 38. For example, a ratio of the first thickness to the second thickness may be less than or equal to 0.95:1.

A second primer layer 56 is positioned over and in direct contact with the second metallic layer 54. The second primer layer 56 can be a single film or a multiple film layer. The second primer layer 56 can include an oxygen-capturing material that can be sacrificial during the deposition process to prevent degradation or oxidation of the second metallic layer 54 during the sputtering process or subsequent heating processes. The second primer layer 56 can also absorb at least a portion of electromagnetic radiation, such as, visible light, passing through the functional coating 30. Examples of materials useful for the second primer layer 56 include those described for the first primer layer 40, such as titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof. In one non-limiting embodiment, the second primer layer 56 comprises titanium, titanium and aluminum, or zinc and aluminum, which are deposited as a metal and at least a portion of the titanium, or titanium and aluminum, or zinc and aluminum are subsequently oxidized. In another embodiment, the second primer layer 56 comprises a nickel-chromium alloy, such as, Inconel. In another embodiment, the second primer layer 56 comprises a cobalt-chromium alloy, such as, Stellite®.

The second primer layer 56 can have a thickness in the range of from 0.5 nm to 5 nm, such as from 1 nm to 4 nm, such as from 1.5 nm to 3.5 nm, or such as from 2 nm to 3 nm.

A third dielectric layer 58 is positioned over and in direct contact with the second primer layer 56. The third dielectric layer 58 can comprise one or more metal oxide, metal alloy oxide, metal nitride, metal alloy nitride, metal oxynitride, or metal alloy oxynitride-containing films, such as, those described above with respect to the first film 34 and second film 36 of the first dielectric layer 32. The third dielectric layer 58 is free of silicon nitride. The third dielectric layer 58 is free of metallic zinc. For example, the third dielectric layer 58 can include a first metal oxide film 60, e.g., a zinc oxide film, deposited over the second primer layer 56 and a second metal alloy film 62, e.g., a zinc stannate film, deposited over at least a portion of the first metal oxide film 60 (FIG. 2).

The first film 60 of the third dielectric layer 58 may comprise a thickness in the range of from 4 nm to 12 nm, such as from 5 nm to 11 nm, such as from 6 nm to 10 nm, or such as from 7 nm to 9 nm.

The second film 62 of the third dielectric layer 58 may comprise a thickness in the range of from 12 nm to 22 nm, such as from 13 nm to 21 nm, such as from 16 nm to 20 nm, or such as from 16.5 nm to 19 nm.

The third dielectric layer 58 may further comprise an optional third metal alloy or metal alloy oxynitride film, e.g., a zinc stannate film or a silicon aluminum oxynitride film, deposited over at least a portion of the second metal alloy film 62. For example, the third dielectric layer 58 can include a first metal alloy film 60, e.g., a zinc stannate film, deposited over the second primer layer 56 and a metal oxynitride film 62, e.g., a silicon aluminum oxynitride film, deposited over at least a portion of the first metal alloy film 60. The third dielectric layer 58 can include a first metal oxide film 60, e.g., a zinc oxide film or an aluminum zinc oxide film, deposited over the second primer layer 56, a second metal alloy film 62, e.g., a zinc stannate film, deposited over at least a portion of the first film 60, and a third metal alloy oxynitride film, e.g., a silicon aluminum oxynitride film, deposited over the second zinc stannate film 62. The third dielectric layer 58 can include a first metal oxide film 60, e.g., a zinc oxide film or an aluminum zinc oxide film, deposited over the second primer layer 56, a second metal alloy film 62, e.g., a zinc stannate film, or a second metal oxide film 62, e.g., a tin oxide film, deposited over at least a portion of the first film 60, and a third metal alloy film, e.g., a zinc stannate film, or a third metal oxide film, e.g., a tin oxide film, deposited over the second zinc stannate film 62 or the second tin oxide film 62. In some non-limiting embodiments, the second film 62 of the third dielectric layer 58 and the third film of the third dielectric layer 58 may comprise the same material. For example, the second film 62 of the third dielectric layer 58 may comprise zinc stannate and the third film of the third dielectric layer 58 may comprise zinc stannate. Alternatively, the second film 62 of the third dielectric layer 58 may comprise tin oxide and the third film of the third dielectric layer 58 may comprise tin oxide.

The third dielectric layer 58 may comprise a total combined thickness (e.g., combined thickness of the first film 60, second film 62, and optional third film) in the range of from 16 nm to 34 nm, such as from 18 nm to 32 nm, such as from 22 nm to 30 nm, or such as from 23.5 nm to 28 nm.

A protective layer 64 is positioned over and in direct contact with at least a portion of the third dielectric layer 58, for example, the second film 62 of the third dielectric layer 58 (FIG. 2). The protective layer 64 is the outermost layer of the functional coating 30.

The protective layer 64 can help protect the underlying functional coating layers, from mechanical and/or chemical attack. The protective layer 64 can be an oxygen barrier coating layer to prevent or reduce the passage of ambient oxygen into the underlying layers of the coating, such as, during heating or bending. The protective layer 64 can be of any desired material or mixture of materials. For example, the protective layer 64 comprises at least one of Si₃N₄, SiAlN, SiAlON, SiAlO, TiAlO, titania, alumina, silica, zirconia, or combinations thereof. For example, the protective layer 64 comprises titania.

The protective layer 64 may comprise a single film and comprises a thickness in the range of from 2 nm to 9 nm, such as from 3 nm to 8 nm, such as from 3.5 nm to 7.5 nm, or such as from 4.5 nm to 6.5 nm.

Alternatively, the protective layer 64 may comprise a first protective film and a second protective film over at least a portion of the first protective film. In one embodiment, the first protective film comprises a metal nitride film, e.g., a silicon aluminum nitride, disposed over and in contact with metal oxynitride film (e.g., silicon aluminum oxynitride) of the third dielectric layer 58 and the second protective film comprises a metal alloy oxide, such as titanium aluminum oxide, disposed over and in contact with the first protective film.

In one embodiment, the metal oxynitride film of the third dielectric layer 58 is a metal oxynitride of the same metal as in the first protective metal nitride film that contacts the metal oxynitride film of the third dielectric layer 58. In another embodiment, the metal oxynitride film of the third dielectric layer 58 is a gradient layer wherein the portion of the metal oxynitride film that is closest to the uppermost metal alloy film of the third dielectric layer 58 comprises a greater amount of oxygen, and the opposite portion of the metal oxynitride film, e.g., that is closest to the first protective metal nitride film, comprises a greater amount of nitrogen, for example, in atomic ratios described above. In one embodiment, the metal oxynitride film of the third dielectric layer 58 and the first protective metal nitride film form a continuous, single gradient layer. In another embodiment, the metal oxynitride film of the third dielectric layer 58 is applied over a metal alloy oxide film and/or in between a metal alloy oxide film and the first protective metal nitride film. In another embodiment, the first protective metal nitride film is not present, and the metal oxynitride film of the third dielectric layer 58 is a gradient layer, wherein amount of oxygen in the metal oxynitride film of the third dielectric layer 58 decreases with increased distance from the metal alloy oxide film of third dielectric layer 58. For example, the portion of the metal oxynitride film of the third dielectric layer 58 that is closest to the uppermost metal alloy oxide film of the third dielectric layer 58 comprises a greater amount of oxygen, and the opposite portion of the oxynitride film of the third dielectric layer 58, comprises a greater amount of nitrogen, where the atomic ratio of oxygen and nitrogen in metal oxynitrides is an approximation based on the flow rate of nitrogen (N₂) and the flow rate of O₂. The oxynitride film of the third dielectric layer 58 comprises 0 wt. % oxygen, and not more than 50 wt. % oxygen; not more than 40 wt. % oxygen; not more than 30 wt. % oxygen; not more than 20 wt. % oxygen; not more than 10 wt. % oxygen; not more than 5 wt. % oxygen. Non-limiting examples of useful atomic ratios of oxygen and nitrogen in the oxynitride film of the third dielectric layer 58 include, for example, and without limitation, from 5% to 45% O with from 95% to 55% N; from 10 to 50% O with from 90% to 50% N; from 15% to 40% O to 85% to 60% N; from 20% to 50% O to 80% to 50% N; from 25% to 45% O to 75% to 55% N; from 30% to 50% O to 70% to 50% N; from 40% to 50% O to 60% to 50% N; or 50% O with 50% N.

The metal oxynitride film of the third dielectric layer 58 can have a thickness in the range of from >0 nm to 40 nm, such as, from 7 nm to 40 nm, from 10 nm to 40 nm, from 28 nm to 33 nm, or from 12 nm to 22 nm. In embodiments where the metal oxynitride film of the third dielectric layer 58 is a gradient layer, or where there is no metal nitride film in the protective layer 64, it may have a thickness of from 20 nm to 40 nm, such as, from 22.5 nm to 39 nm, such as, from 25 nm to 38 nm, such as, from 28 nm to 37.5 nm.

The first protective metal nitride film can have a thickness in the range of from >0 nm to 40 nm, such as, from 7 nm to 40 nm, such as, from 10 nm to 40 nm, such as, from 25 nm to 40 nm, such as, from 28 nm to 33 nm, such as, from 20 nm to 25 nm, such as, from 20 nm to 40 nm, such as, from 10 nm to 16 nm. In embodiments where there is no metal oxynitride film of the third dielectric layer 58 and/or no second protective film, the first protective metal nitride film can have a thickness in the range of 10 nm to 40 nm, preferably, 25 nm to 40 nm, most preferably, 28 nm to 33 nm. In embodiments where the third dielectric layer 58 has a metal oxynitride film and the protective layer 64 has a second protective film, the first protective metal nitride film can have a thickness of 10 nm to 40 nm, such as, from 10 nm to 33 nm, such as, from 10.5 nm to 30 nm, such as, from 11.5 nm to 25 nm. In embodiments where the protective layer 64 has both a first protective metal nitride film and a second protective film, the metal oxynitride film of the third dielectric layer 58 can have a thickness of from 5 nm to 28 nm, such as, from 7.5 nm to 26 nm, such as, from 10 nm to 24 nm, such as, from 12 nm to 22 nm.

In certain embodiments, the invention has a combined thickness of the metal oxynitride film of the third dielectric layer 58 (if present) and/or the first protective metal nitride film (if present) of between 20 nm and 80 nm, for example, 32 nm to 80 nm, 32 nm to 38 nm, or 28 nm to 37 nm.

In certain embodiments, the protective layer 64 can comprise a second protective film comprising TiAlO. Non-limiting examples of the second protective film may have a thickness range of such as, from 10 nm to 40 nm, such as, from 20 nm to 37 nm, such as, from 24.5 nm to 30 nm, such as, from 28.5 nm to 30 nm. It is to be understood that the second protective film may be applied, e.g., as the top-most layer, to any other configuration of the top layer, metal nitride films, and metal oxynitride films consistent with the present disclosure. Alternatively, additional functional layers or protective layers may be applied over the second protective film (not shown). This additional protective film can be any of the materials used to form the protective layer 64, or the second protective film, or any material that may be used as a topcoat. Similarly, it is to be understood that a coated article need not include a second protective film.

When the protective layer 64 comprises a plurality of layers, the protective layer 64 has a total thickness (i.e., the sum of all of the thickness of the layers or films within the protective layer 64) in the range of from 20 nm to 80 nm, such as, from 30 nm to 70 nm, such as, from 35 nm to 60 nm, such as, from 40 nm to 55 nm.

The functional coating 30 is the only coating on the substrate 12 (i.e., there are no other coatings on the substrate 12). For example, there is no coating on the first surface 14 when the functional coating 30 is on the second surface 16 of the substrate 12.

The functional coating 30 is a temperable coating. In the practice of the invention, it is desired to maintain the color of the coated article 10 before and after tempering.

The functional coating 30 provides a reference IGU SHGC of less than or equal to 0.38, such as less than or equal to 0.37, or such as less than or equal to 0.36.

The functional coating 30 provides a reference IGU with a visible light transmittance (LTA) of at least 67%, or such as at least 69%.

The functional coating 30 provides a reference IGU with an external visible light reflectance of less than or equal to 18%, or such as less than or equal to 16%. The functional coating 30 provides a reference IGU with an internal visible light reflectance of less than or equal to 18%, or such as less than or equal to 16%.

The functional coating 30 provides a transmission of less than 50% over a range of wavelengths from 350 nm to 395 nm. The functional coating provides a transmission of less than 20% over a range of wavelengths from 795 nm to 2700 nm.

The coated articles 10 described herein can be used in an architectural transparency.

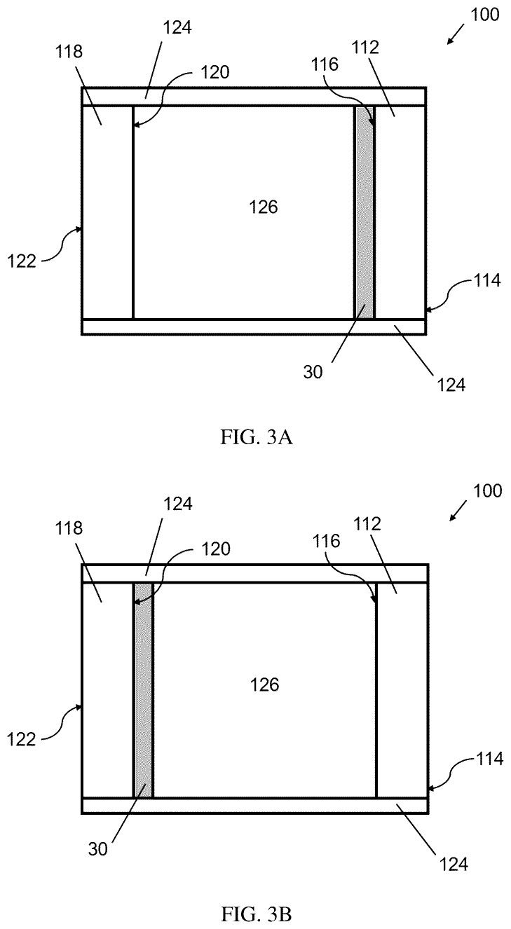

Also provided herein is a coated transparency 100. The coated transparency 100 may be an architectural glazing, such as, but not limited to, an insulating glass unit (IGU), as shown in FIGS. 3A and 3B. The coated transparency comprises a first substrate 112 comprising a No. 1 surface 114 and a No. 2 surface 116 opposite the No. 1 surface 114 and a second substrate 118 comprising a No. 3 surface 120 and a No. 4 surface 122 opposite the No. 3 surface 120. The second substrate 118 is spaced apart from the first substrate 112 and the No. 3 surface 120 faces the No. 2 surface 116. The first substrate 112 and the second substrate 118 are connected together. In the illustrated non-limiting embodiment of FIGS. 3A and 3B, the No. 1 surface 114 faces the building exterior, i.e., is an outer major surface, and the No. 2 surface 116 faces the interior of the building.

The first substrate 112 and the second substrate 118 may be any of the substrates described herein. The first substrate 112 and the second substrate 118 can have any desired visible light, infrared radiation, or ultraviolet radiation transmission and/or reflection. For example, the first substrate 112 and the second substrate 118 can have a visible light transmission of any desired amount, e.g., greater than 0% up to 100%. The first substrate 112 and the second substrate 118 can each be, for example, clear float glass or can be tinted or colored glass or one of the substrates 112, 118 can be clear glass and the other substrate 112, 118 colored glass. Although not limiting to the invention, examples of glass suitable for the first substrate 112 and/or second substrate 118 are described in U.S. Pat. Nos. 4,746,347; 4,792,536; 5,030,593; 5,030,594; 5,240,886; 5,385,872; and 5,393,593. Examples of insulating glass units are found, for example, in U.S. Pat. Nos. 4,193,236; 4,464,874; 5,088,258; and 5,106,663.

The first substrate 112 and the second substrate 118 are connected together in any suitable manner, such as, by being adhesively bonded to a conventional spacer frame 124. A gap or chamber 126 is formed between the first substrate 112 and the second substrate 118. The chamber 126 can be filled with a selected atmosphere, such as, air, or a non-reactive gas such as, argon or krypton gas.

The functional coating 30 may be positioned over the No. 2 surface 116 of the first substrate 112, as shown in FIG. 3A. Alternatively, the functional coating 30 may be positioned over the No. 3 surface 120 of the second substrate 118, as shown in FIG. 3B. The functional coating 30 is any of the functional coatings 30 described herein. The functional coating 30 includes the first dielectric layer 32 positioned over and in direct contact with at least a portion of the No. 2 surface 116 of the first substrate 112 or the No. 3 surface 120 of the second substrate 118, the first metallic layer 38 comprising a first thickness positioned over at least a portion of the first dielectric layer 32, the first primer layer 40 positioned over and in direct contact with at least a portion of the first metallic layer 38, the second dielectric layer 42 positioned over and in direct contact with at least a portion of the first primer layer 40, wherein the second dielectric layer 42 includes a first film 44 positioned over and in direct contact with at least a portion of the first primer layer 40, a second film 46 positioned over and in direct contact with at least a portion of the first film 44, a third film 48 positioned over and in direct contact with at least a portion of the second film 46, a fourth film 50 positioned over and in direct contact with at least a portion of the third film 48, and a fifth film 52 positioned over and in direct contact with at least a portion of the fourth film 50, a second metallic layer 54 comprising a second thickness positioned over and in direct contact with at least a portion of the fifth film 52 of the second dielectric layer 42, the second primer layer 56 positioned over and in direct contact with at least a portion of the second metallic layer 54, the third dielectric layer 58 positioned over and in direct contact with at least a portion of the second primer layer 56, and the protective layer 64 is positioned over and in direct contact with at least a portion of the third dielectric layer 58. The first dielectric layer 32 can be any of the first dielectric layers 32 described herein. The first metallic layer 38 can be any of the first metallic layers 38 described herein. The first primer layer 40 can be any of the first primer layers 40 described herein. The second dielectric layer 42 can be any of the second dielectric layers 42 described herein. The first film 44, second film 46, third film 48, fourth film 50, and fifth film 52 of the second dielectric layer 42 can be any of the first films 44, second films 46, third films 48, fourth films 50, and fifth films 52 described herein. The second metallic layer 54 can be any of the second metallic layers 54 described herein. The second primer layer 56 can be any of the second primer layers 56 described herein. The third dielectric layer 58 can be any of the third dielectric layers 58 described herein. The protective layer 64 can be any of the protective layers 64 described herein.

The coated transparency 100 comprises a SHGC of less than 0.38, such as less than 0.37, or such as less than 0.36.

The coated transparency 100 has a visible light transmittance (LTA) of at least 67%, or such as at least 69%.

The coated transparency 100 comprises an external visible light reflectance of less than or equal to 18%, or such as less than or equal to 16%. The coated transparency comprises an internal visible light reflectance of less than or equal to 18%, or such as less than or equal to 16%.

When the functional coating 30 is on the No. 2 surface 116 of the first substrate 112, the functional coating 30 is the only coating on the first substrate 112. When the functional coating 30 is on the No. 3 surface 120 of the second substrate 118, the functional coating 30 is the only coating on the second substrate 118.

Also provided herein is a method of reducing a SHGC of an insulating glass unit. The method comprises providing a first substrate 112 comprising a No. 1 surface 114 and a No. 2 surface 116 opposite the No. 1 surface 112; providing a second substrate 118 comprising a No. 3 surface 120 and a No. 4 surface 122 opposite the No. 3 surface 120, wherein the second substrate 118 is spaced apart from the first substrate 112, wherein the No. 3 surface 120 faces the No. 2 surface 116, and wherein the first substrate 112 and the second substrate 118 are connected together; and forming a functional coating 30 over at least a portion of the No. 2 surface 116 of the first substrate 118 or the No. 3 surface 120 of the second substrate 118. Forming the functional coating 30 comprises: forming a first dielectric layer 32 over at least a portion of the No. 2 surface 116 of the first substrate 112 or the No. 3 surface 120 of the second substrate 118; forming a first metallic layer 38 comprising a first thickness over at least a portion of the first dielectric layer 32; forming a first primer layer 40 over at least a portion of the first metallic layer 38; forming a second dielectric layer 42 over at least a portion of the first primer layer 40, wherein forming the second dielectric layer 42 comprises: forming a first film 44 over at least a portion of the first primer layer 40, forming a second film 46 over at least a portion of the first film 44, forming a third film 48 over at least a portion of the second film 46, forming a fourth film 50 over at least a portion of the third film 48, and forming a fifth film 52 over at least a portion of the fourth film 50; forming a second metallic layer 54 comprising a second thickness over at least a portion of the fifth film 52 of the second dielectric layer 42; forming a second primer layer 56 over at least a portion of the second metallic layer 54; forming a third dielectric layer 58 over at least a portion of the second primer layer 56; and forming a protective layer 64 over at least a portion of the third dielectric layer 58. The functional coating 30 provides the insulating glass unit with a SHGC of less than or equal to 0.38, such as less than or equal to 0.37, or such as less than or equal to 0.36.

The functional coating 30 can be any of the functional coatings 30 described herein. The first dielectric layer 32 can be any of the first dielectric layers 32 described herein. The first metallic layer 38 can be any of the first metallic layers 38 described herein. The first primer layer 40 can be any of the first primer layers 40 described herein. The second dielectric layer 42 can be any of the second dielectric layers 42 described herein. The first film 44, second film 46, third film 48, fourth film 50, and fifth film 52 of the second dielectric layer 42 can be any of the first films 44, second films 46, third films 48, fourth films 50, and fifth films 52 described herein. The second metallic layer 54 can be any of the second metallic layers 54 described herein. The second primer layer 56 can be any of the second primer layers 56 described herein. The third dielectric layer 58 can be any of the third dielectric layers 58 described herein. The protective layer 64 can be any of the protective layers 64 described herein.

Also provided herein is a method of making a coated article. The method comprises: providing a substrate 12 comprising a first surface 14 and a second surface 16 opposite the first surface 14; and forming a functional coating 30 over at least a portion of the second surface 16 of the substrate 12. Forming the functional coating 30 comprises: forming a first dielectric layer 32 over at least a portion of the second surface 16 of the substrate 12; forming a first metallic layer 38 comprising a first thickness over at least a portion of the first dielectric layer 32; forming a first primer layer 40 over at least a portion of the first metallic layer 38; forming a second dielectric layer 42 positioned over at least a portion of the first primer layer 40, wherein forming the second dielectric layer 42 comprises: forming a first film 44 over at least a portion of the first primer layer 40, forming a second film 46 over at least a portion of the first film 44, forming a third film 48 over at least a portion of the second film 46, forming a fourth film 50 over at least a portion of the third film 48, and forming a fifth film 52 over at least a portion of the fourth film 50; forming a second metallic layer 54 comprising a second thickness over at least a portion of the fifth film 52 of the second dielectric layer 42; forming a second primer layer 56 over at least a portion of the second metallic layer 54; forming a third dielectric layer 58 over at least a portion of the second primer layer 56; and forming a protective layer 64 over at least a portion of the third dielectric layer 58. The functional coating 30 provides the insulating glass unit with a SHGC of less than or equal to 0.38, such as less than or equal to 0.37, or such as less than or equal to 0.36.

The functional coating 30 can be any of the functional coatings 30 described herein. The first dielectric layer 32 can be any of the first dielectric layers 32 described herein. The first metallic layer 38 can be any of the first metallic layers 38 described herein. The first primer layer 40 can be any of the first primer layers 40 described herein. The second dielectric layer 42 can be any of the second dielectric layers 42 described herein. The first film 44, second film 46, third film 48, fourth film 50, and fifth film 52 of the second dielectric layer 42 can be any of the first films 44, second films 46, third films 48, fourth films 50, and fifth films 52 described herein. The second metallic layer 54 can be any of the second metallic layers 54 described herein. The second primer layer 56 can be any of the second primer layers 56 described herein. The third dielectric layer 58 can be any of the third dielectric layers 58 described herein. The protective layer 64 can be any of the protective layers 64 described herein.

A functional coating 30 according to the invention is provided in the following Table 1.

TABLE 1

| | Exemplary | |
|---|---|---|
| Layer | Material | Thickness |
| First Film of First | Zinc | 18-29 nm |
| Dielectric Layer | Stannate | Preferably 20-27 nm |
| | or Tin | More Preferably 21-26 nm |
| | Oxide | Most Preferably 22.5-24.5 nm |
| Second Film of Second | Zinc Oxide | 4-12 nm |
| Dielectric Layer | | Preferably 5-11 nm |
| | | More Preferably 6-10 nm |
| | | Most Preferably 7-9 nm |
| First Metallic Layer | Silver | 10.5-16.5 nm |
| | | Preferably 11-16 nm |
| | | More Preferably 11.5-15.5 nm |
| | | Most Preferably 12.5-14.5 nm |
| First Primer Layer | Titanium | 0.5-5 nm |
| | | Preferably 1-4 nm |
| | | More Preferably 1.5-3.5 nm |
| | | Most Preferably 2-3 nm |
| First Film of Second | Zinc Oxide | 4-12 nm |
| Dielectric Layer | | Preferably 5-11 nm |
| | | More Preferably 6-10 nm |
| | | Most Preferably 7-9 nm |
| Second Film of Second | Zinc | 10-45 nm |
| Dielectric Layer | Stannate | Preferably 18-30 nm |
| | | More Preferably 21-26 nm |
| | | Most Preferably 22.5-24.5 nm |
| Third Film of Second | Zinc Oxide | 7-35 nm |
| Dielectric Layer | | Preferably 16-25 nm |
| | | More Preferably 18-23 nm |
| | | Most Preferably 18.5-21.5 nm |
| Fourth Film of Second | Zinc | 10-45 nm |
| Dielectric Layer | Stannate | Preferably 18-31 nm |
| | | More Preferably 19-27 nm |
| | | Most Preferably 23-25 nm |
| Fifth Film of Second | Zinc Oxide | 4-12 nm |
| Dielectric Layer | | Preferably 5-11 nm |
| | | More Preferably 6-10 nm |
| | | Most Preferably 7-9 nm |
| Second Metallic Layer | Silver | 11-18 nm |
| | | Preferably 12-17 nm |
| | | More Preferably 12.5-16.5 nm |
| | | Most Preferably 13.5-15.5 nm |
| Second Primer Layer | Titanium | 0.5-5 nm |
| | | Preferably 1-4 nm |
| | | More Preferably 1.5-3.5 nm |
| | | Most Preferably 2-3 nm |
| First Film of Third | Zinc Oxide | 4-12 nm |
| Dielectric Layer | | Preferably 5-11 nm |
| | | More Preferably 6-10 nm |
| | | Most Preferably 7-9 nm |
| Second Film of Third | Zinc | 12-22 nm |
| Dielectric Layer | Stannate | Preferably 13-21 nm |
| | | More Preferably 16-20 nm |
| | | Most Preferably 16.5-19 nm |
| Protective Layer | Titania | 2-9 nm |
| | | Preferably 3-8 nm |
| | | More Preferably 3.5-7.5 nm |
| | | Most Preferably 4.5-6.5 nm |

The following numbered clauses are illustrative of various aspects of the invention:

Clause 1. A coated article comprising: a substrate comprising a first surface and a second surface opposite the first surface; and a functional coating positioned over at least a portion of the second surface of the substrate, wherein the functional coating comprises: a first dielectric layer positioned over at least a portion of the second surface of the substrate; a first metallic layer positioned over at least a portion of the first dielectric layer, the first metallic layer comprising a first thickness; a first primer layer positioned over at least a portion of the first metallic layer; a second dielectric layer positioned over at least a portion of the first primer layer, the second dielectric layer comprising: a first film positioned over at least a portion of the first primer layer, a second film positioned over at least a portion of the first film, a third film positioned over at least a portion of the second film, a fourth film positioned over at least a portion of the third film, and a fifth film positioned over at least a portion of the fourth film; a second metallic layer positioned over at least a portion of the fifth film of the second dielectric layer, the second metallic layer comprising a second thickness; a second primer layer positioned over at least a portion of the second metallic layer; a third dielectric layer positioned over at least a portion of the second primer layer; and a protective layer positioned over at least a portion of the third dielectric layer, wherein the functional coating provides a reference insulating glass unit (IGU) solar heat gain coefficient (SHGC) of less than or equal to 0.38.

Clause 2. The coated article of clause 1, wherein the functional coating consists of two metallic layers.

Clause 3. The coated article of clause 1 or 2, wherein the functional coating provides a reference IGU SHGC of less than or equal to 0.36.

Clause 4. The coated article of any one of clauses 1 to 3, wherein the first dielectric layer comprises a first film comprising tin oxide or zinc stannate over at least a portion of the second surface of the substrate and a second film comprising zinc oxide over at least a portion of the first film.

Clause 5. The coated article of clause 4, wherein the first film of the first dielectric layer comprises tin oxide.

Clause 6. The coated article of clause 4 or 5, wherein the first film comprises a thickness in the range of from 18 nm to 29 nm, such as from 20 nm to 27 nm, such as from 21 nm to 26 nm, or such as from 22.5 nm to 24.5 nm; and wherein the second film comprises a thickness in the range of from 4 nm to 12 nm, such as from 5 nm to 11 nm, such as from 6 nm to 10 nm, or such as from 7 nm to 9 nm.

Clause 7. The coated article of any one of clauses 1 to 6, wherein the first dielectric layer comprises a total thickness in the range of from 22 nm to 41 nm, such as from 25 nm to 38 nm, such as from 27 nm to 36 nm, or such as from 29.5 nm to 33.5 nm.

Clause 8. The coated article of any one of clauses 1 to 7, wherein the first metallic layer comprises at least one of silver copper, gold, aluminum, mixtures thereof, or alloys thereof.

Clause 9. The coated article of any one of clauses 1 to 8, wherein the first metallic layer comprises silver.

Clause 10. The coated article of any one of clauses 1 to 9, wherein the first thickness ranges from 10.5 nm to 16.5 nm, such as from 11 nm to 16 nm, such as from 11.5 nm to 15.5 nm, or such as from 12.5 nm to 14.5 nm.

Clause 11. The coated article of any one of clauses 1 to 10, wherein the first primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the first primer layer is deposited as a metal and may be subsequently oxidized.

Clause 12. The coated article of any one of clauses 1 to 11, wherein the first primer layer comprises titanium.

Clause 13. The coated article of any one of clauses 1 to 12, wherein the first primer layer comprises a thickness in the range of from 0.5 nm to 5 nm, such as from 1 nm to 4 nm, such as from 1.5 nm to 3.5 nm, or such as from 2 nm to 3 nm.

Clause 14. The coated article of any one of clauses 1 to 13, wherein the first film, the third film, and the fifth film of the second dielectric layer comprise a first material, wherein the second film and the fourth film of the second dielectric layer comprise a second material, and wherein the first material is different from second material.

Clause 15. The coated article of any one of clauses 1 to 14, wherein: the first film of the second dielectric layer comprises zinc oxide; the second film of the second dielectric layer comprises zinc stannate; the third film of the second dielectric layer comprises zinc oxide; the fourth film of the second dielectric layer comprises zinc stannate; and the fifth film of the second dielectric layer comprises zinc oxide.

Clause 16. The coated article of any one of clauses 1 to 15, wherein: the first film of the second dielectric layer comprises a thickness in the range of from 4 nm to 12 nm, such as from 5 nm to 11 nm, such as from 6 nm to 10 nm, or such as from 7 nm to 9 nm; the second film of the second dielectric layer comprises a thickness in the range of from 10 nm to 45 nm, such as from 18 nm to 30 nm, such as from 21 nm to 26 nm, or such as from 22.5 nm to 24.5 nm; the third film of the second dielectric layer comprises a thickness in the range of from 7 nm to 35 nm, such as from 16 nm to 25 nm, such as from 18 nm to 23 nm, or such as from 18.5 nm to 21.5 nm; the fourth film of the second dielectric layer comprises a thickness in the range of from 10 nm to 45 nm, such as from 18 nm to 31 nm, such as from 19 nm to 27 nm, or such as from 23 nm to 25 nm; and the fifth film of the second dielectric layer comprises a thickness in the range of from 4 nm to 12 nm, such as from 5 nm to 11 nm, such as from 6 nm to 10 nm, or such as from 7 nm to 9 nm.

Clause 17. The coated article of any one of clauses 1 to 16, wherein the second dielectric layer comprises a total thickness in the range of from 35 nm to 149 nm, such as from 62 nm to 108 nm, such as from 70 nm to 96 nm, or such as from 78 nm to 89 nm.

Clause 18. The coated article of any one of clauses 1 to 17, wherein the second metallic layer comprises at least one of silver copper, gold, aluminum, mixtures thereof, or alloys thereof.

Clause 19. The coated article of any one of clauses 1 to 18, wherein the second metallic layer comprises silver.

Clause 20. The coated article of any one of clauses 1 to 19, wherein the second thickness ranges from 11 nm to 18 nm, such as from 12 nm to 17 nm, such as from 12.5 nm to 16.5 nm, or such as from 13.5 nm to 15.5 nm.

Clause 21. The coated article of any one of clauses 1 to 20, wherein the second thickness is greater than the first thickness.

Clause 22. The coated article of any one of clauses 1 to 21, wherein a ratio of the first thickness to the second thickness is less than or equal to 0.95:1.

Clause 23. The coated article of any one of clauses 1 to 22, wherein the second primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the second primer layer is deposited as a metal and may be subsequently oxidized.

Clause 24. The coated article of any one of clauses 1 to 23, wherein the second primer layer comprises titanium.

Clause 25. The coated article of any one of clauses 1 to 24, wherein the second primer layer comprises a thickness in the range of from 0.5 nm to 5 nm, such as from 1 nm to 4 nm, such as from 1.5 nm to 3.5 nm, or such as from 2 nm to 3 nm.

Clause 26. The coated article of any one of clauses 1 to 25 1, wherein the third dielectric layer comprises a first film comprising zinc oxide over at least a portion of the second primer layer and a second film comprising zinc stannate over at least a portion of the first film.

Clause 27. The coated article of clause 26, wherein the first film comprises a thickness in the range of from 4 nm to 12 nm, such as from 5 nm to 11 nm, such as from 6 nm to 10 nm, or such as from 7 nm to 9 nm; and wherein the second film comprises a thickness in the range of from 12 nm to 22 nm, such as from 13 nm to 21 nm, such as from 16 nm to 20 nm, or such as from 16.5 nm to 19 nm.

Clause 28. The coated article of any one of clauses 1 to 27, wherein the third dielectric layer comprises a total thickness in the range of from 16 nm to 34 nm, such as from 18 nm to 32 nm, such as from 22 nm to 30 nm, or such as from 23.5 nm to 28 nm.

Clause 29. The coated article of any one of clauses 1 to 28, wherein the first dielectric layer, the second dielectric layer, and the third dielectric layer are free of silicon nitride.

Clause 30. The coated article of any one of clauses 1 to 28, wherein the first dielectric layer, the second dielectric layer, and the third dielectric layer are free of metallic zinc.

Clause 31. The coated article of any one of clauses 1 to 30, wherein the protective layer is the outermost layer of the functional coating.

Clause 32. The coated article of claim 29, wherein the protective layer comprises a thickness in the range of from 2 nm to 9 nm, such as from 3 nm to 8 nm, such as from 3.5 nm to 7.5 nm, or such as from 4.5 nm to 6.5 nm.

Clause 33. The coated article of any one of clauses 1 to 32, wherein the functional coating provides a reference insulating glass unit (IGU) with a visible light transmittance (LTA) of at least 67%, or such as at least 69%.

Clause 34. The coated article of any one of clauses 1 to 33, wherein the functional coating provides a transmission of less than 50% over a range of wavelengths from 350 nm to 395 nm.

Clause 35. The coated article of any one of clauses 1 to 34, wherein the functional coating provides a transmission of less than 20% over a range of wavelengths from 795 nm to 2700 nm.

Clause 36. The coated article of any one of clauses 1 to 35, wherein the functional coating is a temperable coating.

Clause 37. The coated article of any one of clauses 1 to 36, wherein the functional coating is the only coating on the substrate.

Clause 38. The coated article of any one of clauses 1 to 37, wherein the substrate comprises glass.

Clause 39. A coated transparency comprising: a first substrate comprising a No. 1 surface and a No. 2 surface opposite the No. 1 surface, a second substrate comprising a No. 3 surface and a No. 4 surface opposite the No. 3 surface, wherein the second substrate is spaced apart from the first substrate, wherein the No. 3 surface faces the No. 2 surface, and wherein the first substrate and the second substrate are connected together; and a functional coating positioned over the No. 2 surface of the first substrate or the No. 3 surface of the second substrate, wherein the functional coating comprises: a first dielectric layer positioned over at least a portion of the No. 2 surface of the first substrate or the No. 3 surface of the second substrate; a first metallic layer positioned over at least a portion of the first dielectric layer, the first metallic layer comprising a first thickness; a first primer layer positioned over at least a portion of the first metallic layer; a second dielectric layer positioned over at least a portion of the first primer layer, the second dielectric layer comprising: a first film positioned over at least a portion of the first primer layer, a second film positioned over at least a portion of the first film, a third film positioned over at least a portion of the second film, a fourth film positioned over at least a portion of the third film, and a fifth film positioned over at least a portion of the fourth film; a second metallic layer positioned over at least a portion of the fifth film of the second dielectric layer, the second metallic layer comprising a second thickness; a second primer layer positioned over at least a portion of the second metallic layer; a third dielectric layer positioned over at least a portion of the second primer layer; and a protective layer positioned over at least a portion of the third dielectric layer, wherein the coated transparency comprises a solar heat gain coefficient (SHGC) of less than 0.38.

Clause 40. The coated transparency of clause 39, wherein the functional coating consists of two metallic layers.

Clause 41. The coated transparency of clause 39 or 40, wherein the functional coating provides a reference IGU SHGC of less than or equal to 0.36.

Clause 42. The coated transparency of any one of clauses 39 to 41, wherein the first dielectric layer comprises a first film comprising tin oxide or zinc stannate over at least a portion of the No. 2 surface of the first substrate and a second film comprising zinc oxide over at least a portion of the first film.

Clause 43. The coated transparency of clause 42, wherein the first film of the first dielectric layer comprises tin oxide.

Clause 44. The coated transparency of clause 42 or 43, wherein the first film comprises a thickness in the range of from 18 nm to 29 nm, such as from 20 nm to 27 nm, such as from 21 nm to 26 nm, or such as from 22.5 nm to 24.5 nm; and wherein the second film comprises a thickness in the range of from 4 nm to 12 nm, such as from 5 nm to 11 nm, such as from 6 nm to 10 nm, or such as from 7 nm to 9 nm.

Clause 45. The coated transparency of any one of clauses 39 to 44, wherein the first dielectric layer comprises a total thickness in the range of from 22 nm to 41 nm, such as from 25 nm to 38 nm, such as from 27 nm to 36 nm, or such as from 29.5 nm to 33.5 nm.

Clause 46. The coated transparency of any one of clauses 39 to 45, wherein the first metallic layer comprises at least one of silver copper, gold, aluminum, mixtures thereof, or alloys thereof.

Clause 47. The coated transparency of any one of clauses 39 to 46, wherein the first metallic layer comprises silver.

Clause 48. The coated transparency of any one of clauses 39 to 47, wherein the first thickness ranges from 10.5 nm to 16.5 nm, such as from 11 nm to 16 nm, such as from 11.5 nm to 15.5 nm, or such as from 12.5 nm to 14.5 nm.

Clause 49. The coated transparency of any one of clauses 39 to 48, wherein the first primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the first primer layer is deposited as a metal and may be subsequently oxidized.

Clause 50. The coated transparency of any one of clauses 39 to 49, wherein the first primer layer comprises titanium.

Clause 51. The coated transparency of any one of clauses 39 to 50, wherein the first primer layer comprises a thickness in the range of from 0.5 nm to 5 nm, such as from 1 nm to 4 nm, such as from 1.5 nm to 3.5 nm, or such as from 2 nm to 3 nm.

Clause 52. The coated transparency of any one of clauses 39 to 51, wherein the first film, the third film, and the fifth film of the second dielectric layer comprise a first material, wherein the second film and the fourth film of the second dielectric layer comprise a second material, and wherein the first material is different from second material.

Clause 53. The coated transparency of any one of clauses 39 to 52, wherein: the first film of the second dielectric layer comprises zinc oxide; the second film of the second dielectric layer comprises zinc stannate; the third film of the second dielectric layer comprises zinc oxide; the fourth film of the second dielectric layer comprises zinc stannate; and the fifth film of the second dielectric layer comprises zinc oxide.

Clause 54. The coated transparency of any one of clauses 39 to 53, wherein: the first film of the second dielectric layer comprises a thickness in the range of from 4 nm to 12 nm, such as from 5 nm to 11 nm, such as from 6 nm to 10 nm, or such as from 7 nm to 9 nm; the second film of the second dielectric layer comprises a thickness in the range of from 10 nm to 45 nm, such as from 18 nm to 30 nm, such as from 21 nm to 26 nm, or such as from 22.5 nm to 24.5 nm; the third film of the second dielectric layer comprises a thickness in the range of from 7 nm to 35 nm, such as from 16 nm to 25 nm, such as from 18 nm to 23 nm, or such as from 18.5 nm to 21.5 nm; the fourth film of the second dielectric layer comprises a thickness in the range of from 10 nm to 45 nm, such as from 18 nm to 31 nm, such as from 19 nm to 27 nm, or such as from 23 nm to 25 nm; and the fifth film of the second dielectric layer comprises a thickness in the range of from 4 nm to 12 nm, such as from 5 nm to 11 nm, such as from 6 nm to 10 nm, or such as from 7 nm to 9 nm.

Clause 55. The coated transparency of any one of clauses 39 to 54, wherein the second dielectric layer comprises a total thickness in the range of from 35 nm to 149 nm, such as from 62 nm to 108 nm, such as from 70 nm to 96 nm, or such as from 78 nm to 89 nm.

Clause 56. The coated transparency of any one of clauses 39 to 55, wherein the second metallic layer comprises at least one of silver copper, gold, aluminum, mixtures thereof, or alloys thereof.

Clause 57. The coated transparency of any one of clauses 39 to 56, wherein the second metallic layer comprises silver.

Clause 58. The coated transparency of any one of clauses 39 to 57, wherein the second thickness ranges from 11 nm to 18 nm, such as from 12 nm to 17 nm, such as from 12.5 nm to 16.5 nm, or such as from 13.5 nm to 15.5 nm.

Clause 59. The coated transparency of any one of clauses 39 to 58, wherein the second thickness is greater than the first thickness.

Clause 60. The coated transparency of any one of clauses 39 to 59, wherein a ratio of the first thickness to the second thickness is less than or equal to 0.95:1.

Clause 61. The coated transparency of any one of clauses 39 to 60, wherein the second primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the second primer layer is deposited as a metal and may be subsequently oxidized.

Clause 62. The coated transparency of any one of clauses 39 to 61, wherein the second primer layer comprises titanium.

Clause 63. The coated transparency of any one of clauses 39 to 62, wherein the second primer layer comprises a thickness in the range of from 0.5 nm to 5 nm, such as from 1 nm to 4 nm, such as from 1.5 nm to 3.5 nm, or such as from 2 nm to 3 nm.

Clause 64. The coated transparency of any one of clauses 39 to 63, wherein the third dielectric layer comprises a first film comprising zinc oxide over at least a portion of the second primer layer and a second film comprising zinc stannate over at least a portion of the first film.

Clause 65. The coated transparency of clause 64, wherein the first film comprises a thickness in the range of from 4 nm to 12 nm, such as from 5 nm to 11 nm, such as from 6 nm to 10 nm, or such as from 7 nm to 9 nm; and wherein the second film comprises a thickness in the range of from 12 nm to 22 nm, such as from 13 nm to 21 nm, such as from 16 nm to 20 nm, or such as from 16.5 nm to 19 nm.

Clause 66. The coated transparency of any one of clauses 39 to 65, wherein the third dielectric layer comprises a total thickness in the range of from 16 nm to 34 nm, such as from 18 nm to 32 nm, such as from 22 nm to 30 nm, or such as from 23.5 nm to 28 nm.

Clause 67. The coated transparency of any one of clauses 39 to 66, wherein the first dielectric layer, the second dielectric layer, and the third dielectric layer are free of silicon nitride.

Clause 68. The coated transparency of any one of clauses 39 to 66, wherein the first dielectric layer, the second dielectric layer, and the third dielectric layer are free of metallic zinc.

Clause 69. The coated transparency of any one of clauses 39 to 68, wherein the protective layer is the outermost layer of the functional coating.

Clause 70. The coated transparency of any one of clauses 39 to 69, wherein the protective layer comprises titania.

Clause 71. The coated transparency of any one of clauses 39 to 70, wherein the protective layer comprises a thickness in the range of from 2 nm to 9 nm, such as from 3 nm to 8 nm, such as from 3.5 nm to 7.5 nm, or such as from 4.5 nm to 6.5 nm.

Clause 72. The coated transparency of any one of clauses 39 to 71, wherein the coated transparency has a visible light transmittance (LTA) of at least 67%, or such as at least 69%.

Clause 73. The coated transparency of any one of clauses 39 to 72, wherein the functional coating provides a transmission of less than 50% over a range of wavelengths from 350 nm to 395 nm.

Clause 74. The coated transparency of any one of clauses 39 to 73, wherein the functional coating provides a transmission of less than 20% over a range of wavelengths from 795 nm to 2700 nm.

Clause 75. The coated transparency of any one of clauses 39 to 74, wherein the functional coating is a temperable coating.

Clause 76. The coated transparency of any one of clauses 39 to 75, wherein the functional coating is the only coating on the first substrate or the second substrate.

Clause 77. The coated transparency of any one of clauses 39 to 76, wherein the first substrate and the second substrate comprise glass.

Clause 78. A method of reducing a solar heat gain coefficient (SHGC) of an insulating glass unit, the method comprising: providing a first substrate comprising a No. 1 surface and a No. 2 surface opposite the No. 1 surface; providing a second substrate comprising a No. 3 surface and a No. 4 surface opposite the No. 3 surface, wherein the second substrate is spaced apart from the first substrate, wherein the No. 3 surface faces the No. 2 surface, and wherein the first substrate and the second substrate are connected together; and forming a functional coating over at least a portion of the No. 2 surface of the first substrate or the No. 3 surface of the second substrate, wherein forming the functional coating comprises: forming a first dielectric layer over at least a portion of the No. 2 surface of the first substrate or the No. 3 surface of the second substrate; forming a first metallic layer over at least a portion of the first dielectric layer, the first metallic layer comprising a first thickness; forming a first primer layer over at least a portion of the first metallic layer; forming a second dielectric layer over at least a portion of the first primer layer, wherein forming the second dielectric layer comprises: forming a first film over at least a portion of the first primer layer, forming a second film over at least a portion of the first film, forming a third film over at least a portion of the second film, forming a fourth film over at least a portion of the third film, and forming a fifth film over at least a portion of the fourth film; forming a second metallic layer over at least a portion of the fifth film of the second dielectric layer, the second metallic layer comprising a second thickness; forming a second primer layer over at least a portion of the second metallic layer; forming a third dielectric layer over at least a portion of the second primer layer; and forming a protective layer over at least a portion of the third dielectric layer, wherein the functional coating provides the insulating glass unit with a SHGC of less than or equal to 0.38.

Clause 79. The method of clause 78, wherein the functional coating consists of two metallic layers.

Clause 80. The method of clause 78 or 79, wherein the functional coating provides a reference IGU SHGC of less than or equal to 0.36.

Clause 81. The method of any one of clauses 78 to 80, wherein the first dielectric layer comprises a first film comprising tin oxide or zinc stannate over at least a portion of the second surface of the substrate and a second film comprising zinc oxide over at least a portion of the first film.

Clause 82. The method of clause 81, wherein the first film of the first dielectric layer comprises tin oxide.

Clause 83. The method of clause 81 or 82, wherein the first film comprises a thickness in the range of from 18 nm to 29 nm, such as from 20 nm to 27 nm, such as from 21 nm to 26 nm, or such as from 22.5 nm to 24.5 nm; and wherein the second film comprises a thickness in the range of from 4 nm to 12 nm, such as from 5 nm to 11 nm, such as from 6 nm to 10 nm, or such as from 7 nm to 9 nm.

Clause 84. The method of any one of clauses 78 to 83, wherein the first dielectric layer comprises a total thickness in the range of from 22 nm to 41 nm, such as from 25 nm to 38 nm, such as from 27 nm to 36 nm, or such as from 29.5 nm to 33.5 nm.

Clause 85. The method of any one of clauses 78 to 84, wherein the first metallic layer comprises at least one of silver copper, gold, aluminum, mixtures thereof, or alloys thereof.

Clause 86. The method of any one of clauses 78 to 85, wherein the first metallic layer comprises silver.

Clause 87. The method of any one of clauses 78 to 86, wherein the first thickness ranges from 10.5 nm to 16.5 nm, such as from 11 nm to 16 nm, such as from 11.5 nm to 15.5 nm, or such as from 12.5 nm to 14.5 nm.

Clause 88. The method of any one of clauses 78 to 87, wherein the first primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the first primer layer is deposited as a metal and may be subsequently oxidized.

Clause 89. The method of any one of clauses 78 to 88, wherein the first primer layer comprises titanium.

Clause 90. The method of any one of clauses 78 to 89, wherein the first primer layer comprises a thickness in the range of from 0.5 nm to 5 nm, such as from 1 nm to 4 nm, such as from 1.5 nm to 3.5 nm, or such as from 2 nm to 3 nm.

Clause 91. The method of any one of clauses 78 to 90, wherein the first film, the third film, and the fifth film of the second dielectric layer comprise a first material, wherein the second film and the fourth film of the second dielectric layer comprise a second material, and wherein the first material is different from second material.

Clause 92. The method of any one of clauses 78 to 91, wherein: the first film of the second dielectric layer comprises zinc oxide; the second film of the second dielectric layer comprises zinc stannate; the third film of the second dielectric layer comprises zinc oxide; the fourth film of the second dielectric layer comprises zinc stannate; and the fifth film of the second dielectric layer comprises zinc oxide.

Clause 93. The method of any one of clauses 78 to 92, wherein: the first film of the second dielectric layer comprises a thickness in the range of from 4 nm to 12 nm, such as from 5 nm to 11 nm, such as from 6 nm to 10 nm, or such as from 7 nm to 9 nm; the second film of the second dielectric layer comprises a thickness in the range of from 10 nm to 45 nm, such as from 18 nm to 30 nm, such as from 21 nm to 26 nm, or such as from 22.5 nm to 24.5 nm; the third film of the second dielectric layer comprises a thickness in the range of from 7 nm to 35 nm, such as from 16 nm to 25 nm, such as from 18 nm to 23 nm, or such as from 18.5 nm to 21.5 nm; the fourth film of the second dielectric layer comprises a thickness in the range of from 10 nm to 45 nm, such as from 18 nm to 31 nm, such as from 19 nm to 27 nm, or such as from 23 nm to 25 nm; and the fifth film of the second dielectric layer comprises a thickness in the range of from 4 nm to 12 nm, such as from 5 nm to 11 nm, such as from 6 nm to 10 nm, or such as from 7 nm to 9 nm.

Clause 94. The method of any one of clauses 78 to 93, wherein the second dielectric layer comprises a total thickness in the range of from 35 nm to 149 nm, such as from 62 nm to 108 nm, such as from 70 nm to 96 nm, or such as from 78 nm to 89 nm.

Clause 95. The method of any one of clauses 78 to 94, wherein the second metallic layer comprises at least one of silver copper, gold, aluminum, mixtures thereof, or alloys thereof.

Clause 96. The method of any one of clauses 78 to 95, wherein the second metallic layer comprises silver.

Clause 97. The method of any one of clauses 78 to 96, wherein the second thickness ranges from 11 nm to 18 nm, such as from 12 nm to 17 nm, such as from 12.5 nm to 16.5 nm, or such as from 13.5 nm to 15.5 nm.

Clause 98. The method of any one of clauses 78 to 97, wherein the second thickness is greater than the first thickness.

Clause 99. The method of any one of clauses 78 to 98, wherein a ratio of the first thickness to the second thickness is less than or equal to 0.95:1.

Clause 100. The method of any one of clauses 78 to 99, wherein the second primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the second primer layer is deposited as a metal and may be subsequently oxidized.

Clause 101. The method of any one of clauses 78 to 100, wherein the second primer layer comprises titanium.

Clause 102. The method of any one of clauses 78 to 101, wherein the second primer layer comprises a thickness in the range of from 0.5 nm to 5 nm, such as from 1 nm to 4 nm, such as from 1.5 nm to 3.5 nm, or such as from 2 nm to 3 nm.

Clause 103. The method of any one of clauses 78 to 102, wherein the third dielectric layer comprises a first film comprising zinc oxide over at least a portion of the second primer layer and a second film comprising zinc stannate over at least a portion of the first film.

Clause 104. The method of clause 103, wherein the first film comprises a thickness in the range of from 4 nm to 12 nm, such as from 5 nm to 11 nm, such as from 6 nm to 10 nm, or such as from 7 nm to 9 nm; and wherein the second film comprises a thickness in the range of from 12 nm to 22 nm, such as from 13 nm to 21 nm, such as from 16 nm to 20 nm, or such as from 16.5 nm to 19 nm.

Clause 105. The method of any one of clauses 78 to 104, wherein the third dielectric layer comprises a total thickness in the range of from 16 nm to 34 nm, such as from 18 nm to 32 nm, such as from 22 nm to 30 nm, or such as from 23.5 nm to 28 nm.

Clause 106. The method of any one of clauses 78 to 105, wherein the first dielectric layer, the second dielectric layer, and the third dielectric layer are free of silicon nitride.

Clause 107. The method of any one of clauses 78 to 105, wherein the first dielectric layer, the second dielectric layer, and the third dielectric layer are free of metallic zinc.

Clause 108. The method of any one of clauses 78 to 107, wherein the protective layer is the outermost layer of the functional coating.

Clause 109. The method of any one of clauses 78 to 108, wherein the protective layer comprises titania.

Clause 110. The method of any one of clauses 78 to 109, wherein the protective layer comprises a thickness in the range of from 2 nm to 9 nm, such as from 3 nm to 8 nm, such as from 3.5 nm to 7.5 nm, or such as from 4.5 nm to 6.5 nm.

Clause 111. The method of any one of clauses 78 to 110, wherein the functional coating provides a reference insulating glass unit (IGU) with a visible light transmittance (LTA) of at least 67%, or such as at least 69%.

Clause 112. The method of any one of clauses 78 to 111, wherein the functional coating provides a transmission of less than 50% over a range of wavelengths from 350 nm to 395 nm.

Clause 113. The method of any one of clauses 78 to 112, wherein the functional coating provides a transmission of less than 20% over a range of wavelengths from 795 nm to 2700 nm.

Clause 114. The method of any one of clauses 78 to 113, further comprising tempering the coated article.

Clause 115. The method of any one of clauses 78 to 114, wherein the functional coating is the only coating on the first substrate or the second substrate.

Clause 116. The method of any one of clauses 78 to 115, wherein the first substrate and second substrate comprises glass.

Clause 117. A method of making a coated article, the method comprising: providing a substrate comprising a first surface and a second surface opposite the first surface; and forming a functional coating over at least a portion of the second surface of the substrate, wherein forming the functional coating comprises: forming a first dielectric layer over at least a portion of the second surface of the substrate; forming a first metallic layer over at least a portion of the first dielectric layer, the first metallic layer comprising a first thickness; forming a first primer layer over at least a portion of the first metallic layer; forming a second dielectric layer over at least a portion of the first primer layer, wherein forming the second dielectric layer comprises: forming a first film over at least a portion of the first primer layer, forming a second film over at least a portion of the first film, forming a third film over at least a portion of the second film, forming a fourth film over at least a portion of the third film, and forming a fifth film over at least a portion of the fourth film; forming a second metallic layer over at least a portion of the fifth film of the second dielectric layer, the second metallic layer comprising a second thickness; forming a second primer layer over at least a portion of the second metallic layer; forming a third dielectric layer over at least a portion of the second primer layer; and forming a protective layer over at least a portion of the third dielectric layer, wherein the functional coating provides a reference insulating glass unit (IGU) solar heat gain coefficient (SHGC) of less than or equal to 0.38.

Clause 118. The method of clause 117, wherein the functional coating consists of two metallic layers.

Clause 119. The method of clause 117 or 118, wherein the functional coating provides a reference IGU SHGC of less than or equal to 0.36.

Clause 120. The method of any one of clauses 117 to 119, wherein the first dielectric layer comprises a first film comprising tin oxide or zinc stannate over at least a portion of the second surface of the substrate and a second film comprising zinc oxide over at least a portion of the first film.

Clause 121. The method of clause 120, wherein the first film of the first dielectric layer comprises tin oxide.

Clause 122. The method of clause 120 or 121, wherein the first film comprises a thickness in the range of from 18 nm to 29 nm, such as from 20 nm to 27 nm, such as from 21 nm to 26 nm, or such as from 22.5 nm to 24.5 nm; and wherein the second film comprises a thickness in the range of from 4 nm to 12 nm, such as from 5 nm to 11 nm, such as from 6 nm to 10 nm, or such as from 7 nm to 9 nm.

Clause 123. The method of any one of clauses 117 to 122, wherein the first dielectric layer comprises a total thickness in the range of from 22 nm to 41 nm, such as from 25 nm to 38 nm, such as from 27 nm to 36 nm, or such as from 29.5 nm to 33.5 nm.

Clause 124. The method of any one of clauses 117 to 123, wherein the first metallic layer comprises at least one of silver copper, gold, aluminum, mixtures thereof, or alloys thereof.

Clause 125. The method of any one of clauses 117 to 124, wherein the first metallic layer comprises silver.

Clause 126. The method of any one of clauses 117 to 125, wherein the first thickness ranges from 10.5 nm to 16.5 nm, such as from 11 nm to 16 nm, such as from 11.5 nm to 15.5 nm, or such as from 12.5 nm to 14.5 nm.

Clause 127. The method of any one of clauses 117 to 126, wherein the first primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the first primer layer is deposited as a metal and may be subsequently oxidized.

Clause 128. The method of any one of clauses 117 to 127, wherein the first primer layer comprises titanium.

Clause 129. The method of any one of clauses 117 to 128, wherein the first primer layer comprises a thickness in the range of from 0.5 nm to 5 nm, such as from 1 nm to 4 nm, such as from 1.5 nm to 3.5 nm, or such as from 2 nm to 3 nm.

Clause 130. The method of any one of clauses 117 to 129, wherein the first film, the third film, and the fifth film of the second dielectric layer comprise a first material, wherein the second film and the fourth film of the second dielectric layer comprise a second material, and wherein the first material is different from second material.

Clause 131. The method of any one of clauses 117 to 130, wherein: the first film of the second dielectric layer comprises zinc oxide; the second film of the second dielectric layer comprises zinc stannate; the third film of the second dielectric layer comprises zinc oxide; the fourth film of the second dielectric layer comprises zinc stannate; and the fifth film of the second dielectric layer comprises zinc oxide.

Clause 132. The method of any one of clauses 117 to 131, wherein: the first film of the second dielectric layer comprises a thickness in the range of from 4 nm to 12 nm, such as from 5 nm to 11 nm, such as from 6 nm to 10 nm, or such as from 7 nm to 9 nm; the second film of the second dielectric layer comprises a thickness in the range of from 10 nm to 45 nm, such as from 18 nm to 30 nm, such as from 21 nm to 26 nm, or such as from 22.5 nm to 24.5 nm; the third film of the second dielectric layer comprises a thickness in the range of from 7 nm to 35 nm, such as from 16 nm to 25 nm, such as from 18 nm to 23 nm, or such as from 18.5 nm to 21.5 nm; the fourth film of the second dielectric layer comprises a thickness in the range of from 10 nm to 45 nm, such as from 18 nm to 31 nm, such as from 19 nm to 27 nm, or such as from 23 nm to 25 nm; and the fifth film of the second dielectric layer comprises a thickness in the range of from 4 nm to 12 nm, such as from 5 nm to 11 nm, such as from 6 nm to 10 nm, or such as from 7 nm to 9 nm.

Clause 133. The method of any one of clauses 117 to 132, wherein the second dielectric layer comprises a total thickness in the range of from 35 nm to 149 nm, such as from 62 nm to 108 nm, such as from 70 nm to 96 nm, or such as from 78 nm to 89 nm.

Clause 134. The method of any one of clauses 117 to 133, wherein the second metallic layer comprises at least one of silver copper, gold, aluminum, mixtures thereof, or alloys thereof.

Clause 135. The method of any one of clauses 117 to 134, wherein the second metallic layer comprises silver.

Clause 136. The method of any one of clauses 117 to 135, wherein the second thickness ranges from 11 nm to 18 nm, such as from 12 nm to 17 nm, such as from 12.5 nm to 16.5 nm, or such as from 13.5 nm to 15.5 nm.

Clause 137. The method of any one of clauses 117 to 136, wherein the second thickness is greater than the first thickness.

Clause 138. The method of any one of clauses 117 to 137, wherein a ratio of the first thickness to the second thickness is less than or equal to 0.95:1.

Clause 139. The method of any one of clauses 117 to 138, wherein the second primer layer is selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and wherein the second primer layer is deposited as a metal and may be subsequently oxidized.

Clause 140. The method of any one of clauses 117 to 139, wherein the second primer layer comprises titanium.

Clause 141. The method of any one of clauses 117 to 140, wherein the second primer layer comprises a thickness in the range of from 0.5 nm to 5 nm, such as from 1 nm to 4 nm, such as from 1.5 nm to 3.5 nm, or such as from 2 nm to 3 nm.

Clause 142. The method of any one of clauses 117 to 141, wherein the third dielectric layer comprises a first film comprising zinc oxide over at least a portion of the second primer layer and a second film comprising zinc stannate over at least a portion of the first film.

Clause 143. The method of clause 142, wherein the first film comprises a thickness in the range of from 4 nm to 12 nm, such as from 5 nm to 11 nm, such as from 6 nm to 10 nm, or such as from 7 nm to 9 nm; and wherein the second film comprises a thickness in the range of from 12 nm to 22 nm, such as from 13 nm to 21 nm, such as from 16 nm to 20 nm, or such as from 16.5 nm to 19 nm.

Clause 144. The method of any one of clauses 117 to 143, wherein the third dielectric layer comprises a total thickness in the range of from 16 nm to 34 nm, such as from 18 nm to 32 nm, such as from 22 nm to 30 nm, or such as from 23.5 nm to 28 nm.

Clause 145. The method of any one of clauses 117 to 144, wherein the first dielectric layer, the second dielectric layer, and the third dielectric layer are free of silicon nitride.

Clause 146. The method of any one of clauses 117 to 144, wherein the first dielectric layer, the second dielectric layer, and the third dielectric layer are free of metallic zinc.

Clause 147. The method of any one of clauses 117 to 146, wherein the protective layer is the outermost layer of the functional coating.

Clause 148. The method of any one of clauses 117 to 147, wherein the protective layer comprises titania.

Clause 149. The method of any one of clauses 117 to 148, wherein the protective layer comprises a thickness in the range of from 2 nm to 9 nm, such as from 3 nm to 8 nm, such as from 3.5 nm to 7.5 nm, or such as from 4.5 nm to 6.5 nm.

Clause 150. The method of any one of clauses 117 to 149, wherein the functional coating provides a reference insulating glass unit (IGU) with a visible light transmittance (LTA) of at least 67%, or such as least 69%.

Clause 151. The method of any one of clauses 117 to 150, wherein the functional coating provides a transmission of less than 50% over a range of wavelengths from 350 nm to 395 nm.

Clause 152. The method of any one of clauses 117 to 151, wherein the functional coating provides a transmission of less than 20% over a range of wavelengths from 795 nm to 2700 nm.

Clause 153. The method of any one of clauses 117 to 152, further comprising tempering the coated article.

Clause 154. The method of any one of clauses 117 to 153, wherein the functional coating is the only coating on the substrate.

Clause 155. The method of any one of clauses 117 to 154, wherein the substrate comprises glass.

### Examples

Nine coated articles having functional coatings 30 according to the invention were prepared. The functional coatings 30 had the compositions and the thicknesses as described in Table 1. The substrate 12 was a 6 millimeter glass substrate. The functional coating 30 was applied on the second surface 16 of the glass substrate 12. There were no coatings on the first surface 14 of the glass substrate 12. Samples 1-9 were heated.

Various optical and performance properties of insulating glass units were modeled using the properties obtained for the coated articles of Samples 1-9. The coated articles of Samples 1-9 were used as the first substrate 112, where the functional coating 30 was on the No. 2 surface 116. The second substrate 118 was a 6 mm clear glass substrate. There were no coatings on the No. 3 surface 120 or the No. 4 surface 122 of the second substrate 118. The first glass substrate 112 and the second glass substrate 114 were spaced a half inch apart in the model and the gap was modeled with air. The optical, performance, and color properties of the insulating glass units (Examples 1-9) can be found in Tables 2-4. “R(ext)” is the external reflectance, “R(int)” is the internal reflectance, “SC” is the shading coefficient, “SHGC” is the solar heat gain coefficient, and “LSG” is the light to solar gain ratio.

TABLE 2

| Ex- | | | | | | | |
|---|---|---|---|---|---|---|---|
| am- | Visible | | | Solar | | | UV |
| ple | T | R(ext) | R(int) | T | R(ext) | R(int) | T |
| 1 | 70.0% | 14.3% | 15.0% | 30.7% | 33.4% | 34.5% | 12.6% |
| 2 | 70.3% | 14.2% | 14.8% | 30.7% | 33.5% | 34.6% | 12.5% |
| 3 | 70.2% | 14.4% | 15.0% | 30.5% | 33.8% | 34.8% | 12.7% |
| 4 | 70.1% | 14.2% | 14.9% | 30.8% | 33.5% | 34.4% | 12.4% |
| 5 | 70.4% | 14.1% | 14.8% | 30.9% | 33.3% | 34.4% | 12.3% |
| 6 | 69.8% | 15.0% | 15.5% | 30.5% | 34.1% | 35.0% | 14.7% |
| 7 | 69.6% | 14.4% | 15.1% | 30.6% | 33.6% | 34.4% | 12.6% |
| 8 | 70.0% | 14.2% | 14.8% | 31.0% | 32.9% | 34.0% | 12.8% |
| 9 | 69.8% | 14.4% | 15.1% | 31.1% | 32.9% | 33.8% | 12.8% |

TABLE 3

| | U Factor | | | | | | |
|---|---|---|---|---|---|---|---|
| | Winter | | Summer | | | | |
| | Btu/ | W/ | Btu/ | W/ | | | |
| Example | h-ft²-F | m²-K | h-ft²-F | m²-K | SC | SHGC | LSG |
| 1 | 0.288 | 1.634 | 0.268 | 1.523 | 0.407 | 0.354 | 1.98 |
| 2 | 0.290 | 1.646 | 0.271 | 1.540 | 0.407 | 0.354 | 1.98 |
| 3 | 0.289 | 1.640 | 0.270 | 1.531 | 0.404 | 0.352 | 2.00 |
| 4 | 0.288 | 1.636 | 0.269 | 1.526 | 0.408 | 0.355 | 1.97 |
| 5 | 0.289 | 1.642 | 0.270 | 1.534 | 0.409 | 0.356 | 1.98 |
| 6 | 0.289 | 1.640 | 0.270 | 1.531 | 0.404 | 0.352 | 1.98 |
| 7 | 0.289 | 1.638 | 0.269 | 1.528 | 0.405 | 0.353 | 1.98 |
| 8 | 0.290 | 1.646 | 0.271 | 1.540 | 0.411 | 0.358 | 1.95 |
| 9 | 0.290 | 1.646 | 0.271 | 1.540 | 0.413 | 0.359 | 1.94 |

TABLE 4

| | Transmitted Color | | | R(ext) Color | | | R(int) Color | | |
|---|---|---|---|---|---|---|---|---|---|
| Example | L* | a* | b* | L* | a* | b* | L* | a* | b* |
| 1 | 86.95 | −4.18 | 3.96 | 44.82 | −2.18 | −8.71 | −8.71 | −5.58 | −3.40 |
| 2 | 87.08 | −4.36 | 4.15 | 44.70 | −2.23 | −9.34 | −9.34 | −5.26 | −4.08 |
| 3 | 87.03 | −4.51 | 4.17 | 44.93 | −2.23 | −9.40 | −9.40 | −5.49 | −4.22 |
| 4 | 86.99 | −4.33 | 4.36 | 44.78 | −1.24 | −10.08 | −10.08 | −4.69 | −4.36 |
| 5 | 87.17 | −4.63 | 4.34 | 44.57 | −1.83 | −9.83 | −9.83 | −4.75 | −4.44 |
| 6 | 86.89 | −4.28 | 3.89 | 45.89 | −2.25 | −9.31 | −9.31 | −5.36 | −4.42 |
| 7 | 86.80 | −4.12 | 3.30 | 44.96 | −1.87 | −7.10 | −7.10 | −5.94 | −2.15 |
| 8 | 86.94 | −4.34 | 3.70 | 44.63 | −1.60 | −7.99 | −7.99 | −5.06 | −2.88 |
| 9 | 86.89 | −4.10 | 3.10 | 44.89 | −2.02 | −6.13 | −6.13 | −5.70 | −1.35 |

It will be readily appreciated by those skilled in the art that modification may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A coated article comprising:
a substrate comprising a first surface and a second surface opposite the first surface; and
a functional coating positioned over at least a portion of the second surface of the substrate, wherein the functional coating comprises:
a first dielectric layer positioned over at least a portion of the second surface of the substrate;
a first metallic layer positioned over at least a portion of the first dielectric layer, the first metallic layer comprising a first thickness;
a first primer layer positioned over at least a portion of the first metallic layer;
a second dielectric layer positioned over at least a portion of the first primer layer, the second dielectric layer comprising:
a first film positioned over at least a portion of the first primer layer,
a second film positioned over at least a portion of the first film,
a third film positioned over at least a portion of the second film,
a fourth film positioned over at least a portion of the third film, and
a fifth film positioned over at least a portion of the fourth film;
a second metallic layer positioned over at least a portion of the fifth film of the second dielectric layer, the second metallic layer comprising a second thickness;
a second primer layer positioned over at least a portion of the second metallic layer;
a third dielectric layer positioned over at least a portion of the second primer layer; and
a protective layer positioned over at least a portion of the third dielectric layer,
wherein the functional coating provides a reference insulating glass unit (IGU) solar heat gain coefficient (SHGC) of less than or equal to 0.38.

2. The coated article of claim 1, wherein the functional coating consists of two metallic layers.

3. The coated article of claim 1, wherein the functional coating provides a reference IGU SHGC of less than or equal to 0.36.

4. The coated article of claim 1, wherein the first dielectric layer comprises a first film comprising tin oxide or zinc stannate over at least a portion of the second surface of the substrate and a second film comprising zinc oxide over at least a portion of the first film.

5. The coated article of claim 1, wherein the first dielectric layer comprises a total thickness in the range of from 22 nm to 41 nm, such as from 25 nm to 38 nm, such as from 27 nm to 36 nm, or such as from 29.5 nm to 33.5 nm.

6. The coated article of claim 1, wherein the first metallic layer comprises at least one of silver copper, gold, aluminum, mixtures thereof, or alloys thereof, and
wherein the first thickness ranges from 10.5 nm to 16.5 nm, such as from 11 nm to 16 nm, such as from 11.5 nm to 15.5 nm, or such as from 12.5 nm to 14.5 nm.

7. The coated article of claim 1, wherein the first film, the third film, and the fifth film of the second dielectric layer comprise a first material,
wherein the second film and the fourth film of the second dielectric layer comprise a second material, and
wherein the first material is different from second material.

8. The coated article of claim 7, wherein:
the first film of the second dielectric layer comprises zinc oxide;
the second film of the second dielectric layer comprises zinc stannate;
the third film of the second dielectric layer comprises zinc oxide;
the fourth film of the second dielectric layer comprises zinc stannate; and
the fifth film of the second dielectric layer comprises zinc oxide.

9. The coated article of claim 1, wherein the second dielectric layer comprises a total thickness in the range of from 35 nm to 149 nm, such as from 62 nm to 108 nm, such as from 70 nm to 96 nm, or such as from 78 nm to 89 nm.

10. The coated article of claim 1, wherein the second metallic layer comprises at least one of silver copper, gold, aluminum, mixtures thereof, or alloys thereof, and
wherein the second thickness ranges from 11 nm to 18 nm, such as from 12 nm to 17 nm, such as from 12.5 nm to 16.5 nm, or such as from 13.5 nm to 15.5 nm.

11. The coated article of claim 1, wherein the second thickness is greater than the first thickness.

12. The coated article of claim 1, wherein a ratio of the first thickness to the second thickness is less than or equal to 0.95:1.

13. The coated article of claim 1, wherein the first primer layer and the second primer layer are each independently selected from titanium, cobalt, silicon, zinc, aluminum, vanadium, tungsten, tantalum, niobium, zirconium, manganese, chromium, tin, nickel, gallium, indium, germanium, magnesium, molybdenum, silver, silicon carbide, aluminum-doped silver aluminum zinc, vanadium zinc, tungsten tantalum, titanium niobium, zirconium niobium, tungsten niobium, aluminum niobium, aluminum titanium, tungsten titanium, tantalum titanium, zinc titanium, aluminum silver, zinc tin, indium zinc, silver zinc, mixtures thereof, and alloys thereof, and
wherein the first primer layer and the second primer layer are deposited as a metal and may be subsequently oxidized.

14. The coated article of claim 1, wherein the third dielectric layer comprises a first film comprising zinc oxide over at least a portion of the second primer layer and a second film comprising zinc stannate over at least a portion of the first film.

15. The coated article of claim 1, wherein the third dielectric layer comprises a total thickness in the range of from 16 nm to 34 nm, such as from 18 nm to 32 nm, such as from 22 nm to 30 nm, or such as from 23.5 nm to 28 nm.

16. The coated article of claim 1, wherein the first dielectric layer, the second dielectric layer, and the third dielectric layer are free of silicon nitride, and
wherein the first dielectric layer, the second dielectric layer, and the third dielectric layer are free of metallic zinc.

17. The coated article of claim 1, wherein the functional coating provides a reference insulating glass unit (IGU) with a visible light transmittance (LTA) of at least 67%, or such as at least 69%.

18. The coated article of claim 1, wherein the functional coating provides a transmission of less than 50% over a range of wavelengths from 350 nm to 395 nm, or
wherein the functional coating provides a transmission of less than 20% over a range of wavelengths from 795 nm to 2700 nm.

19. A coated transparency comprising:
a first substrate comprising a No. 1 surface and a No. 2 surface opposite the No. 1 surface,
a second substrate comprising a No. 3 surface and a No. 4 surface opposite the No. 3 surface,
wherein the second substrate is spaced apart from the first substrate,
wherein the No. 3 surface faces the No. 2 surface, and
wherein the first substrate and the second substrate are connected together; and
a functional coating positioned over the No. 2 surface of the first substrate or the No. 3 surface of the second substrate, wherein the functional coating comprises:
a first dielectric layer positioned over at least a portion of the No. 2 surface of the first substrate or the No. 3 surface of the second substrate;
a first metallic layer positioned over at least a portion of the first dielectric layer, the first metallic layer comprising a first thickness;
a first primer layer positioned over at least a portion of the first metallic layer;
a second dielectric layer positioned over at least a portion of the first primer layer, the second dielectric layer comprising:
a first film positioned over at least a portion of the first primer layer,
a second film positioned over at least a portion of the first film,
a third film positioned over at least a portion of the second film,
a fourth film positioned over at least a portion of the third film, and
a fifth film positioned over at least a portion of the fourth film;
a second metallic layer positioned over at least a portion of the fifth film of the second dielectric layer, the second metallic layer comprising a second thickness;
a second primer layer positioned over at least a portion of the second metallic layer;
a third dielectric layer positioned over at least a portion of the second primer layer; and
a protective layer positioned over at least a portion of the third dielectric layer,
wherein the coated transparency comprises a solar heat gain coefficient (SHGC) of less than 0.38.

20. A method of reducing a solar heat gain coefficient (SHGC) of an insulating glass unit, the method comprising:
providing a first substrate comprising a No. 1 surface and a No. 2 surface opposite the No. 1 surface;
providing a second substrate comprising a No. 3 surface and a No. 4 surface opposite the No. 3 surface,
wherein the second substrate is spaced apart from the first substrate,
wherein the No. 3 surface faces the No. 2 surface, and
wherein the first substrate and the second substrate are connected together;
forming a functional coating over at least a portion of the No. 2 surface of the first substrate or the No. 3 surface of the second substrate, wherein forming the functional coating comprises:
forming a first dielectric layer over at least a portion of the No. 2 surface of the first substrate or the No. 3 surface of the second substrate;
forming a first metallic layer over at least a portion of the first dielectric layer, the first metallic layer comprising a first thickness;
forming a first primer layer over at least a portion of the first metallic layer;
forming a second dielectric layer over at least a portion of the first primer layer, wherein forming the second dielectric layer comprises:
forming a first film over at least a portion of the first primer layer,
forming a second film over at least a portion of the first film,
forming a third film over at least a portion of the second film,
forming a fourth film over at least a portion of the third film, and
forming a fifth film over at least a portion of the fourth film;
forming a second metallic layer over at least a portion of the fifth film of the second dielectric layer, the second metallic layer comprising a second thickness;
forming a second primer layer over at least a portion of the second metallic layer;
forming a third dielectric layer over at least a portion of the second primer layer; and
forming a protective layer over at least a portion of the third dielectric layer,
wherein the functional coating provides the insulating glass unit with a SHGC of less than or equal to 0.38.
